(19) United States
(12) Patent Application Publication
(10) Pub. No.: US 2010/0068644 A1
(43) Pub. Date: Mar. 18, 2010

(54) TONER, AND DEVELOPER

(76) Inventors: Hisashi Nakajima, Numazu-shi (JP); Shinya Nakayama, Numazu-shi (JP); Saori Yamada, Numazu-shi (JP); Mitsuo Aoki, Numazu-shi (JP); Hiroyuki Kishida, Numazu-shi (JP); Hyo Shu, Numazu-shi (JP); Yasutada Shitara, Numazu-shi (JP); Masahide Inoue, Numazu-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/557,105

(22) Filed: Sep. 10, 2009

(30) Foreign Application Priority Data
Sep. 12, 2008 (JP) 2008-234347
Nov. 13, 2008 (JP) 2008-291093
Dec. 4, 2008 (JP) 2008-309625
Dec. 25, 2008 (JP) 2008-329928

(51) Int. Cl. G03G 9/087

(52) U.S. Cl. 430/109.4

(57) ABSTRACT

The present invention provides a toner which contains at least a binder resin, and a colorant, wherein the binder resin contains a polyester resin (A) obtained by polycondensation of an alcohol component with a carboxylic acid component containing one of a purified rosin and a modified rosin, and a polyester resin (B) obtained by polycondensation of a carboxylic acid with an alcohol component containing a specific alkylene oxide adduct of bisphenol A, and wherein when the carboxylic acid component containing a purified rosin is used in the carboxylic acid component for the polyester resin (A), a mass ratio [(B)/(A)] of the polyester resin (B) to the polyester resin (A) is 2/8 to 6/4.

### BACKGROUND OF THE INVENTION

1. Field of the Invention

The present invention relates to a toner suitable for use in a super high-speed printing system which can be used in print on demand (POD) technology especially using an electrophotographic printing method, for example, used in copiers, electrostatic printing systems, printers, facsimiles and electrostatic recording systems, and to a developer using the toner.

2. Description of the Related Art

In recent years, market demands for energy saving and higher speed processing have increased for image forming apparatuses such as printers, copiers, and facsimiles. With the increase of such market demands, also in the field of electrophotographic toner (hereinafter, may be simply referred to as “toner”), a demand for a toner having excellent low-temperature fixability increases, while there is a need for a toner having conflicting properties to the low-temperature fixability, such as offset resistance, heat resistant storage stability (blocking resistance), and smear resistance on developing roller.

In order to respond to the demands, for example, there are proposed a toner containing a linear polyester resin having defined physical properties such as molecular weight (see Japanese Patent Application Laid-Open (JP-A) No. 2004-245854); a toner containing a non-linear crosslinked polyester resin using rosins as an acid component (see Japanese Patent Application Laid-Open (JP-A) No. 04-70765); a toner using a maleic acid-modified rosin in order to enhance fixability (see Japanese Patent Application Laid-Open (JP-A) No. 04-307557); and toners using as a binder resin a polyester composed of an alcohol component and a carboxylic acid containing a (meth)acrylic acid-modified rosin (see Japanese Patent Application Laid-Open (JP-A) Nos. 2007-292860 and 2007-292869). Also, there has been proposed a method of blending a low-molecular weight resin with a high-molecular weight resin (see Japanese Patent Application Laid-Open (JP-A) No. 02-82267).

Also, there have been many toners proposed, which use aromatic polyester resins, as a technique to enhance low-temperature fixability, however, these toners have a disadvantage of being inferior in pulverizability at the time of production thereof. To overcome the disadvantage, there has been proposed a method of blending a low-molecular weight polyester using an aliphatic alcohol superior in pulverizability with a high-molecular weight polyester (see Japanese Patent Application Laid-Open (JP-A) No. 2002-287427). However, the low-molecular weight polyester using an aliphatic alcohol of this proposal has a low glass transition temperature because of its chemical structure, and thus the heat resistant storage stability of the toner degrades, making it difficult to satisfy the low-temperature fixability, offset resistance and heat resistant storage stability on a high level.

Meanwhile, a toner is reported using as a binder resin a polyester containing a carboxylic acid component composed of a purified rosin and an alcohol component composed of alcohol (see Japanese Patent Application Laid-Open (JP-A) Nos. 2007-137910 and 2007-139811). The toner is advantageous in having excellent low-temperature fixability on a wide variety of conventional type of image forming apparatuses ranging from low-speed printing machines to high-speed printing machines and satisfying both the low-temperature fixability and heat resistant storage stability on a high level.

In recent years, the market of the print on demand (POD) field has grown substantially, and printing market demands for toner are more and more increasing. The POD technology utilizing an electrophotographic printing method is well suited for printing a small number of copies and for variable printing (printing of images or data varied for each paper sheet) and thus is expected as an alternative to simple printing technology (“keiinsatu”). However, as it is requested to provide a super high-speed printing system that operates at a significantly faster printing speed than the conventional high-speed copiers and to have suitability to a wide variety of paper sheet types, it has become newly required to provide a toner capable of exhibiting excellent fixability even with a smaller amount of heat and causing less contamination on developing rollers and the like.

In the field of print on demand (POD) utilizing an electrophotographic method, it is requested to provide a super high-speed printing system that operates at a significantly faster printing speed than the conventional high-speed copiers and to have suitability to a wide variety of paper sheet types. Therefore, the toner consumption amount is large, and it is undesired to use a toner which is inferior in pulverizability and productivity, like the toner containing a linear polyester resin having defined physical properties such as molecular weight of (JP-A) No. 2004-245854. Also, rosins used in (JP-A) Nos. 04-70765 and 04-307557 are effective in enhancing the low-temperature fixability, but are disadvantageous in that they are liable to cause odor depending on the type of rosins. Furthermore, the toners using as a binder resin a polyester composed of an alcohol component and a carboxylic acid containing a (meth)acrylic acid-modified rosin of (JP-A) Nos. 2007-292860 and 2007-292869 can exhibit excellent fixability on a wide variety of conventional type of image forming apparatuses ranging from low-speed printing machines to high-speed printing machines, but they have difficulty to satisfy both the low-temperature fixability and smear resistance on developing roller and the like on super high-speed printing systems, and they still remain inadequate to meet the above-mentioned new requirements in the print on demand (POD) field.

In the meanwhile, since the POD systems are used in printing market, there is a need to achieve the electrophotographic process with substantially longer operating life than conventional electrophotographic systems for official and domestic use. In particular, fixing devices which are members to be abraded most remarkably among members used in electrophotographic systems, and when such a fixing device has a short operating life, the downtime of the printing machine itself is prolonged due to the replacement with a new fixing device, leading to degradation in printing capability. Thus, achieving longer operating life of POD systems is one of the important subjects to be addressed. Further, against the likelihood of achieving longer operating life of POD systems, the toner consumption amount per POD system unit will be significantly large, a toner is much liable to deteriorate a fixing member than when a conventional electrophotographic system is employed, and thus it is required for toners to be more greatly improved than required for toners used in conventional electrophotographic systems.

In typical electrophotographic image forming apparatuses, fixing devices each have fixing members composed of rollers or a belt which are or is heated at high temperature and a cleaning member and the like. As to toners, a so-called oilless fixing toner is most often used, where a wax dispersed in a toner is melted and exudes to the surface of the toner when the toner is pressed against a heated fixing member, and the adhesion force of the toner to the fixing member is reduced due to the presence of the wax exudates between the fixing member and the toner, and the toner can adhere onto a recording medium without adhering onto the fixing member (see Japanese Patent Application Laid-Open (JP-A) No. 2003-248339 and Japanese Patent (JP-B) No. 3874082). In this case, a toner developed on the recording medium is melted, pressurized by the fixing member and fixed on the recording medium, but a toner which adheres onto the fixing member without being fixed on the recording medium is removed by a cleaning member at the downstream side of the fixing nip region in the fixing device. When the amount of toner adhering on the fixing member is large, smear on the cleaning member is large in amount. Typical electrophotographic systems for official or domestic use often have a cleaning member having high durability and operating life, so long as the system has. In application of POD system where the number of printing paper sheets is much greater than that of a typical electrophotographic system, it is common to replace with new components of a cleaning member. When smear on a cleaning member is serious, the frequency of replacement of cleaning member components becomes high, which involves stopping the printing machine to cause degradation in printing capability. Therefore, it is desired in POD systems to avoid as practicably as possible smear or contamination on cleaning members.

Generally, as fixing problems of electrophotographic systems, there is a phenomenon in which toner adheres onto a fixing member. There are two primary types of phenomena, i.e. cold offset which is caused when the molten state of a toner is inadequate; and hot offset which is caused when a toner is melted in excess. In order to prevent these phenomena, a number of oilless fixing toners as exemplified by JP-A No. 2003-248339 and JP-B No. 3874082 have been proposed so far. Also, Japanese Patent Application Laid-Open (JP-A) No. 2007-79196 proposes a toner containing a wax having a small particle size, which is uniformly dispersed in the toner and is allowed to be present moderately on the surface of the toner. However, the primary technical problem to be solved in these proposals is to prevent the offset phenomenon in which toner on a recording medium collectively adheres onto a fixing member. In contrast to the above proposals, the toner of the present invention is intended to address offset with a very small amount, in which toner adheres onto a fixing member with an amount little by little, and there is an apparent difference in objective function from the toner in the proposal. Such a problem with a very small amount offset is posed in electrophotographic systems for official or domestic use, and as described above, in the POD field where various printing market demands should be met, further development and improvement are required for attaining the very small amount offset property.

Furthermore, Japanese Patent Application Laid-Open (JP-A) Nos. 2007-292858 and 2007-322932 each propose a toner using as a binder resin a polyester resin composed of an alcohol component and a carboxylic acid component containing a fumaric acid-modified rosin. These toners can exhibit their excellent fixability on a wide variety of conventional type of image forming apparatuses ranging from low-speed printing machines to high-speed printing machines, however, have a difficulty to achieve both excellent low-temperature fixability and smear resistance on carrier and developing roller and the like.

It should be noted that the present applicant proposes to use, as a binder resin of a toner for use in an image forming apparatus, a polyester resin which is obtained by polycondensation of an alcohol component containing a divalent aliphatic alcohol having 2 to 6 carbon atoms in an amount of 70 mole % or more of a divalent alcohol component with a carboxylic acid component containing a maleic acid-modified rosin (see Japanese Patent Application Laid-Open (JP-A) No. 2007-292863). With this, it is possible to improve the low-temperature fixability, offset resistance, and storage stability of the toner and to reduce the occurrence of odor. But this proposal is inadequate in achieving these properties and the smear resistance on developing roller and the like and leaves some to be desired.

### BRIEF SUMMARY OF THE INVENTION

The present invention aims to provide a toner which is capable of achieving low-temperature fixability, offset resistance and heat resistant storage stability on a level suitable for use in super high-speed image forming systems, reducing the occurrence of odor and which has remarkable effect of improving smear resistance on developing roller, fixing members and the like and is also excellent in pulverizability and productivity, and a developer using the toner.

Means for solving the aforementioned problems are as follows:

<1> A toner containing at least a binder resin, and a colorant, wherein the binder resin contains a polyester resin (A) which is obtained by polycondensation of an alcohol component with a carboxylic acid component containing one of a purified rosin and a modified rosin, and a polyester resin (B) which is obtained by polycondensation of a carboxylic acid with an alcohol component containing an alkylene oxide adduct of bisphenol A represented by General Formula (1) described below, and wherein when a carboxylic acid component containing a purified rosin is used in the carboxylic acid component for the polyester resin (A), a mass ratio [(B)/(A)] of the polyester resin (B) to the polyester resin (A) is 2/8 to 6/4,

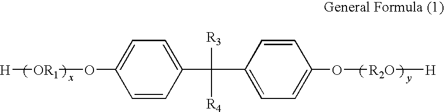

in General Formula (1), R₁ and R₂ are each an alkylene group having 2 to 4 carbon atoms, R₃ and R₄ are each any one of a hydrogen atom, a straight-chain alkyl group having 1 to 6 carbon atoms and a branched alkyl group having 1 to 6 carbon atoms, x and y are each a positive integer, and the sum of x and y is 1 to 16.

<2> The toner according to <1>, wherein when a carboxylic acid component containing a modified rosin is used in the carboxylic acid component for the polyester resin (A), the mass ratio [(B)/(A)] of the polyester resin (B) to the polyester resin (A) is 1/9 to 6/4.

<3> The toner according to <1>, wherein the modified rosin is at least one selected from a (meth)acrylic acid-modified rosin, a fumaric acid-modified rosin, and a maleic acid-modified rosin.

<4> The toner according to <1>, wherein the amount of the modified rosin contained in the carboxylic acid component for the polyester resin (A) is 5% by mass to 85% by mass.

<5> The toner according to <1>, wherein the purified rosin has a softening point of 50° C. to 100° C.

<6> The toner according to <1>, wherein the purified rosin is a purified tall rosin.

<7> The toner according to <1>, wherein the amount of the purified rosin contained in the carboxylic acid component for the polyester resin (A) is 2 mole % to 50 mole %.

<8> The toner according to <1>, wherein the alcohol component for the polyester resin (A) is an aliphatic polyhydric alcohol.

<9> The toner according to <8>, wherein the aliphatic polyhydric alcohol contains an aliphatic polyhydric alcohol having 2 to 6 carbon atoms.

<10> The toner according to <1>, wherein the polyester resin (A) contains at least one of a polyester resin containing a trivalent or higher polyhydric alcohol in the alcohol component for the polyester resin (A), and a polyester resin containing a trivalent or higher polyvalent carboxylic acid compound in the carboxylic acid component for the polyester resin (A).

<11> The toner according to <1>, wherein the polyester resin (A) contains a low-molecular-weight component having a molecular weight of 500 or less in an amount of 12% or less.

<12> The toner according to <1>, wherein the polyester resin (A) is obtained by polycondensation of the alcohol component with the carboxylic acid component in the presence of at least one of a titanium compound and a tin (II) compound having no Sn—C bond.

<13> The toner according to <1>, wherein the polyester resin (B) is obtained by polycondensation of the carboxylic acid component with an alcohol component which contains a divalent alcohol component containing the alkylene oxide adduct of bisphenol A represented by General Formula (1) in an amount of 80 mole % or more.

<14> The toner according to <1>, wherein the polyester resin (B) has a softening point Tm(B) of 80° C. to 160° C.

15> The toner according to <1>, wherein the polyester resin (A) has an acid value of 25 mgKOH/g to 70 mgKOH/g, and the polyester resin (B) has an acid value of 1 mgKOH/g to 25 mgKOH/g.

<16> A developer containing at least a toner, and a carrier, wherein the toner contains at least a binder resin, and a colorant, wherein the binder resin contains a polyester resin (A) which is obtained by polycondensation of an alcohol component with a carboxylic acid component containing one of a purified rosin and a modified rosin, and a polyester resin (B) which is obtained by polycondensation of a carboxylic acid with an alcohol component containing an alkylene oxide adduct of bisphenol A represented by General Formula (1) described below, and wherein when the carboxylic acid component containing a purified rosin is used in the carboxylic acid component for the polyester resin (A), a mass ratio [(B)/(A)] of the polyester resin (B) to the polyester resin (A) is 2/8 to 6/4,

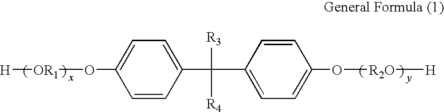

in General Formula (1), R₁ and R₂ are each an alkylene group having 2 to 4 carbon atoms, R₃ and R₄ are each any one of a hydrogen atom, a straight-chain alkyl group having 1 to 6 carbon atoms and a branched alkyl group having 1 to 6 carbon atoms, x and y are each a positive integer, and the sum of x and y is 1 to 16.

<17> An image forming apparatus including at least a latent electrostatic image bearing member, a charging unit configured to charge a surface of the latent electrostatic image bearing member, an exposing unit configured to expose the charged surface of the latent electrostatic image bearing member to form a latent electrostatic image, a developing unit configured to develop the latent electrostatic image using a toner so as to form a visible image, a transfer unit configured to transfer the visible image onto a recording medium, and a fixing unit configured to fix the transferred image on the recording medium, wherein the toner is the toner according to any one of <1>to <15>.

<18> An image forming method including at least charging a surface of a latent electrostatic image bearing member, exposing the charged surface of the latent electrostatic image bearing member to form a latent electrostatic image, developing the latent electrostatic image using a toner to form a visible image, transferring the visible image onto a recording medium, and fixing the transferred image on the recording medium, wherein the toner is the toner according to any one of <1>to <15>.

<19> A process cartridge detachably mounted on a main body of an image forming apparatus, the process cartridge including at least a latent electrostatic image bearing member, and a developing unit configured to develop a latent electrostatic image formed on the latent electrostatic image bearing member using a toner to form a visible image, wherein the toner is the toner according to <1>to <15>.

The present invention can solve various problems in related art and provide a toner which is capable of achieving low-temperature fixability, offset resistance and heat resistant storage stability on the level suitable for use in super high-speed image forming systems, reducing the occurrence of odor and which has remarkable effect of improving smear resistance on developing roller, fixing members and the like and is also excellent in pulverizability and productivity, and a developer using the toner.

### BRIEF DESCRIPTION OF THE DRAWINGS

FIG. 1 is a photograph of a felt showing a contamination degree of “D” in the evaluation criteria for smear resistance on a fixing device in Examples.

FIG. 2 is a photograph of a felt showing a contamination degree of “C” in the evaluation criteria for smear resistance on a fixing device in Examples.

FIG. 3 is a photograph of a felt showing a contamination degree of “B” in the evaluation criteria for smear resistance on a fixing device in Examples.

FIG. 4 is a photograph of a felt showing a contamination degree of “A” in the evaluation criteria for smear resistance on a fixing device in Examples.

FIG. 5 is a schematic cross-sectional diagram showing an example of a process cartridge used in the present invention.

### DETAILED DESCRIPTION OF THE INVENTION

### (Toner)

The toner of the present invention contains at least a binder resin and a colorant, and contains a releasing agent, a charge controlling agent, external additive and further contains other components as required.

### <Binder Resin>

The binder resin contains a polyester resin (A) and a polyester resin (B) and further contains other resins as required.

### —Polyester Resin (A)—

The polyester resin (A) is obtained by polycondensation of an alcohol component with a carboxylic acid component containing one of a purified rosin and a modified rosin, preferably, in the presence of an esterifying catalyst.

### —Alcohol Component—

The alcohol component is not particularly limited and may be suitably selected from among known polyester resins in accordance with the intended use. For the alcohol component, an aliphatic polyhydric alcohol is favorably used.

As the aliphatic polyhydric alcohol, an aliphatic polyhydric alcohol having 2 to 6 carbon atoms is preferably used.

A 1,2-propanediol, which is a branched chain alcohol having 3 carbon atoms, used in the alcohol component is effective in improving low-temperature fixability while maintaining offset resistance as compared to an alcohol having 2 or less carbon atoms and is effective in preventing a reduction in storage stability accompanied by a decrease in glass transition temperature as compared to a branched chain alcohol having 4 or more carbon atoms. The 1,2-propanediol exerts a remarkable effect that the use thereof allows for fixing an image at an extremely low temperature and improving heat resistant storage stability as well as hot offset resistance. Particularly when the amount of 1,2-propanediol is 65 mole % or more in a divalent alcohol component, it exerts excellent low-temperature fixability and offset resistance.

The alcohol component may contain alcohols other than 1,2-propanediol within the range where the purposes and effects of the present invention are not impaired, however, the amount of 1,2-propanediol in the divalent alcohol component is 65 mole % or more, preferably 70 mole % or more, more preferably 80 mole % or more, and still more preferably 90 mole % or more.

Examples of divalent alcohol components other than 1,2-propanediol include 1,3-propanediol, ethylene glycols having a different carbon atoms, hydrogenated bisphenol A, bisphenol F, and aliphatic dialcohols such as alkylene (having 2 to 4 carbon atoms) oxide adducts (with average added moles: 1 to 16) thereof. The amount of the divalent alcohol component in the divalent alcohol component is preferably 60 mole % to 95 mole % and more preferably 65 mole % to 90 mole %.

The alcohol component of the polyester resin (A) preferably contains 1,3-propanediol from the perspective of offset resistance. A molar ratio (1,2-propanediol/1.3-propanediol) of 1,2-propanediol to 1,3-propanediol in each of the alcohol components for the polyester resin (A) and the polyester resin (B) is preferably 99/1 to 65/35, more preferably 95/5 to 70/30, and still more preferably 95/5 to 75/25.

When a trivalent or higher polyhydric alcohol component is contained in the alcohol component(s), it is more effective in improving the hot offset resistance. The amount of the trivalent or higher polyhydric alcohol component in the total amount of the alcohol components is preferably 20 mole % or less, and more preferably 5 mole % to 20 mole %.

Examples of the trivalent or higher polyhydric alcohol component include glycerin, pentaerythritol, trimethylolpropane, sorbitol, and alkylene (having 2 to 4 carbon atoms) oxide adducts (with average added moles: 1 to 16) thereof. Among these, glycerin is particularly preferable in terms that it does not impair low-temperature fixability.

The alcohol component of the polyester resin (A) may contain aromatic alcohols including alkylene oxide adducts of bisphenol A such as polyoxypropylene (2,2)-2,2-bis(4-hydroxyphenyl)propane, and polyoxyethylene (2,2)-2,2-bis(4-hydroxyphenyl)propane, however, the alcohol component of the polyester resin (A) is substantially composed of only aliphatic alcohol. Note that the description “the alcohol component substantially composed of only aliphatic alcohol” means that the amount of the aliphatic alcohol in the alcohol component is 90 mole % or more.

### —Carboxylic Acid Component—

The carboxylic acid component in the polyester resin (A) contains one of a purified rosin and a modified rosin.

### [Purified Rosin]

Rosin used in the purified rosin is a natural resin obtained from pine trees, and the primary component is resin acids, such as abietic acid, neoabietic acid, palustric acid, pimaric acid, isopimaric acid, sandaracopimaric acid, and dehydroabietic acid, and a mixture thereof.

The rosins are broadly classified into tall rosins derived from tall oils which are obtained as by-product in production process of pulp; gum rosins derived from crude turpentine; and wood rosins obtained from pine stubs, and the like. Among these rosins, as the purified rosin used in the present invention, a purified tall rosin is particularly preferable from the perspective of low-temperature fixability. Also, a purified product of a modified resin such as a disproportionated rosin and a hydrogenated rosin can be used, however, in the present invention, it is preferable to use a so-called crude rosin, which is not modified.

The purified rosin is a rosin from which impurities have been removed by purification process. By subjecting a rosin to purification, impurities contained in the rosin are removed. Examples of primary impurities include 2-methyl propane, acetaldehyde, 3-methyl-2-butanone, 2-methyl propanoic acid, butanoic acid, pentanoic acid, n-hexanal, octane, hexanoic acid, benzaldehyde, 2-pentylfuran, 2,6-dimethylcyclohexanone, 1-methyl-2-(1-methylethyl)benzene, 3,5-dimethyl-2-cyclohexene, and 4-(1-methylethyl)benzaldehyde. In the present invention, peak intensities of three types of impurities, from among the above-mentioned impurities, i.e., hexanoic acid, pentanoic acid and benzaldehyde, detected as volatilized components by Headspace GC-MS can be used as indicators of the purified rosin. Note that the reason of using volatilized components as indicators, instead of using the absolute amount of impurities is that the use of a purified rosin in the present invention contributes deodorization, which is one of the improved points of the present invention, as compared to conventional polyester resins each of which contains rosin.

The purified rosin mentioned in the present invention is a rosin of which in the hereinafter described measurement conditions based on Headspace GC-MS, the peak intensity of hexanoic acid is 0.8×10⁷ or less, the peak intensity of pentanoic acid is 0.4×10⁷ or less, and the peak intensity of benzaldehyde is 0.4×10⁷ or less. Further, from the perspective of storage stability and deodorization, the peak intensity of hexanoic acid is preferably 0.6×10⁷ or less and more preferably 0.5×10⁷ or less. The peak intensity of pentanoic acid is preferably 0.3×10⁷ or less and more preferably 0.2×10⁷ or less. The peak intensity of benzaldehyde is preferably 0.3×10⁷ or less and more preferably 0.2×10⁷ or less.

Further, from the perspective of storage stability and deodorization, it is preferable that the amount of impurities of n-hexanal and 2-pentylfuran be reduced, in addition to the above-mentioned three impurities. The peak intensity of n-hexanal is preferably 1.7×10⁷ or less, more preferably 1.6×10⁷ or less, and still more preferably 1.5×10⁷ or less. The peak intensity of 2-pentylfuran is preferably 1.0×10⁷ or less, more preferably 0.9×10⁷ or less, and still more preferably 0.8×10⁷ or less.

The purification method of the rosin is not particularly limited and known methods in the art are utilized. Examples thereof include distillation, recrystallization, and extraction. The rosin is preferably purified by distillation. For the distillation method, for example, the methods described in Japanese Patent Application Laid-Open (JP-A) No. 07-286139 can be used, such as reduced-pressure distillation, molecular distillation and steam distillation. The rosin is preferably purified by reduced-pressure distillation. For example, a distillation is generally carried out under a pressure of 6.67 kPa or less and a still temperature of 200° C. to 300° C., and distillation methods such as thin-layer distillation, rectification distillation, including commonly used simple distillation can be used. In normal distillation conditions, to the used rosin, 2% by mass to 10% by mass of high-molecular weight substances is removed as a pitch portion, and 2% by mass to 10% by mass of an initial fraction is removed.

The softening point of the purified rosin is preferably 50° C. to 100° C., more preferably 60° C. to 90° C., and still more preferably 65° C. to 85° C. The softening point of the purified rosin in the present invention means a softening point measured when a rosin is melted once by the method described hereinbelow in EXAMPLES and then the rosin is naturally cooled for one hour under an environment of a temperature of 25° C. and a relative humidity of 50%.

The acid value of the purified rosin is preferably 100 mgKOH/g to 200 mgKOH/g, more preferably 130 mgKOH/g to 180 mgKOH/g, and still more preferably 150 mgKOH/g to 170 mgKOH/g.

The acid value of the purified rosin can be measured based on, for example, the method described in JIS K0070.

The amount of the purified rosin contained in the carboxylic acid component is preferably 2 mole % to 50 mole %, more preferably 5 mole % to 40 mole %, and still more preferably 10 mole % to 30 mole %.

### [Modified Rosin]

The modified rosin is preferably at least one selected from a (meth)acrylic acid-modified rosin, a fumaric acid-modified rosin, and a maleic acid-modified rosin.

### <(Meth)acrylic Acid-Modified Rosin>

In the present invention, use of a (meth)acrylic acid-modified rosin as the carboxylic acid in the polyester resin (A) makes it possible to fix an image at an extremely low-temperature and to improve storage stability.

Since the (meth)acrylic acid-modified rosin is a rosin having two functional groups, the rosin can extend a molecular chain as a part of its main chain to increase the molecular weight, and meanwhile, use of the rosin makes it possible to reduce the amount of low-molecular-weight components having a molecular weight of 500 or less, i.e., residual monomer components and oligomer components. Therefore, the (meth)acrylic acid-modified rosin is presumed to exert a remarkable effect in that both contradictory physical properties of low-temperature fixability and storage stability can be improved.

The (meth)acrylic acid-modified rosin is a rosin modified with a (meth)acrylic acid, and it can be obtained by addition-reacting a rosin containing, for example, abietic acid, neoabietic acid, palustric acid, pimaric acid, isopimaric acid, sandaracopimaric acid, dehydroabietic acid, and levopimaric acid as main components, with a (meth)acrylic acid. More specifically, the (meth)acrylic acid-modified rosin can be obtained by Diels-Alder reaction of levopimaric acid, abietic acid, neoabietic acid and palustric acid each of which have a conjugated double bond in main components of a rosin, with a (meth)acrylic acid, under heating.

Note that in the present invention, the term “(meth)acrylic” means acrylic or methacrylic. Thus, a (meth)acrylic acid means an acrylic acid or a methacrylic acid, and “(meth)acrylic acid-modified rosin” means a rosin modified with an acrylic acid or a rosin modified with a methacrylic acid. As the (meth)acrylic acid-modified rosin in the present invention, an acrylic acid-modified rosin which is modified with an acrylic acid having less steric hindrance is preferable from the perspective of reaction activity in the Diels-Alder reaction.

The degree of modification of rosin with the (meth)acrylic acid ((meth)acrylic acid-modified degree) is preferably 5 to 105, more preferably 20 to 105, still more preferably 40 to 105, and particularly preferably 60 to 105, from the perspective of increasing the molecular weight of the polyester resin and reducing oligomer components having a low-molecular weight.

The degree of modification of rosin with (meth)acrylic acid can be calculated by the following Equation (1):

Degree of modification of rosin with (meth)acrylic acid=[(X₁−Y)/(X₂−Y)]×100 Equation (1)

In Equation (1), X₁ denotes an SP value of a (meth)acrylic acid-modified rosin whose modification degree is to be calculated, X₂ denotes a saturated SP value of a (meth)acrylic acid-modified rosin obtained by reacting 1 mol of (meth)acrylic acid with 1 mol of a rosin, and Y denotes an SP value of the rosin.

The SP value means a softening point measured by an automatic ring and ball softening point tester, as described hereinbelow in EXAMPLES. The saturated SP value means an SP value obtained in the reaction of the (meth)acrylic acid with the rosin until the SP value of the resulting (meth)acrylic acid-modified rosin reaches a saturated value. In Equation (1), the numerator (X₁−Y) means an increased degree of the SP value of the rosin that has been modified with (meth)acrylic acid, and the greater the value of degree of modification of rosin with (meth)acrylic acid, represented by Equation (1), the higher the modified degree is.

The method of producing the (meth)acrylic acid-modified rosin is not particularly limited and may be suitably selected in accordance with the intended use. For example, a rosin and a (meth)acrylic acid are mixed together, the mixture is heated at a temperature of about 180° C. to about 260° C., and through Diels-Alder reaction, the (meth)acrylic acid is addition-reacted with acids having conjugated double bonds, contained in the rosin, thereby a (meth)acrylic acid-modified rosin can be obtained. The resulting (meth)acrylic acid-modified rosin may be directly used, or may be further purified through distillation or the like before use.

As for a rosin used in the (meth)acrylic acid-modified rosin, any rosin may be employed without particularly limiting to known rosins, as long as it is a rosin containing abietic acid, neoabietic acid, palustric acid, pimaric acid, isopimaric acid, sandaracopimaric acid, dehydroabietic acid, and levopimaric acid as main components, such as a natural rosin obtained from pine trees, an isomerized rosin, a dimerized rosin, a polymerized rosin, and a disproportionated rosin. From the perspective of color, preferred are natural rosins such as tall rosins derived from tall oils which are obtained as by-product in production process of natural rosin pulp; gum rosins derived from crude turpentine; and wood rosins obtained from pine stubs. From the perspective of low-temperature fixability, tall rosins are more preferable.

The (meth)acrylic acid-modified rosin is obtained through Diels-Alder reaction under heating, and thus it contains in a reduced amount impurities causing unpleasant odor and has less odor. From the perspective of further reducing odor and improving storage stability, the (meth)acrylic acid-modified rosin is preferably obtained by modification of a purified rosin with (meth)acrylic acid, and more preferably obtained by modification of a purified tall rosin with (meth)acrylic acid.

The amount of the (meth)acrylic acid-modified rosin contained in the carboxylic acid component is preferably 5% by mass or more, more preferably 8% by mass or more, and still more preferably 10% by mass or more, from the viewpoint of low-temperature fixability. From the viewpoint of storage stability, it is preferably 85% by mass or less, more preferably 70% by mass or less, still more preferably 60% by mass or less, and particularly preferably 50% by mass or less. From these viewpoints, the amount of the (meth)acrylic acid-modified rosin contained in the carboxylic acid component is preferably 5% by mass to 85% by mass, more preferably 5% by mass to 70% by mass, still more preferably 8% by mass to 60% by mass, and particularly preferably 10% by mass to 50% by mass.

### <Fumaric Acid-Modified Rosin>

In the present invention, use of a fumaric acid-modified rosin as the carboxylic acid component makes it possible to fix an image at an extremely low-temperature and to improve heat resistant storage stability.

The fumaric acid-modified rosin has an extremely high glass transition temperature as compared to conventional rosins and maleic acid-modified rosins. Therefore, use of the rosin makes it possible to reduce the amount of low-molecular-weight components, and the fumaric acid-modified rosin is presumed to exert an unexpected remarkable effect in that both contradictory physical properties of low-temperature fixability and storage stability can be improved.

The fumaric acid-modified rosin is a rosin modified with a fumaric acid, and it can be obtained by addition-reacting a rosin containing, for example, abietic acid, neoabietic acid, palustric acid, pimaric acid, isopimaric acid, sandaracopimaric acid, dehydroabietic acid, and levopimaric acid as main components, with a fumaric acid. More specifically, the fumaric acid-modified rosin can be obtained by Diels-Alder reaction of levopimaric acid, abietic acid, neoabietic acid and palustric acid each of which have a conjugated double bond in main components of a rosin, with a fumaric acid, under heating.

The degree of modification of rosin with the fumaric acid (fumaric acid-modified degree) is preferably 5 to 105, more preferably 20 to 105, still more preferably 40 to 105, and particularly preferably 60 to 105 from the perspective of increasing the molecular weight of the resulting polyester resin and improving the glass transition temperature.

The degree of modification of rosin with fumaric acid can be calculated by the following Equation (2):

Degree of modification of rosin with fumaric acid=[(X₁−Y)/(X₂−Y)]×100 Equation (2)

In Equation (2), X₁ denotes an SP value of a fumaric acid-modified rosin whose modification degree is to be calculated, X₂ denotes an SP value of a fumaric acid-modified rosin obtained by reacting 1 mol of fumaric acid with 0.7 mol of a rosin, and Y denotes an SP value of the rosin.

The SP value means a softening point measured by an automatic ring and ball softening point tester, as described hereinbelow in EXAMPLES. In Equation (2), the numerator (X₁−Y) means an increased degree of the SP value of the rosin that has been modified with fumaric acid, and the greater the value of degree of modification of rosin with fumaric acid, represented by Equation (2), the higher the modified degree is.

The glass transition temperature (Tg) of the fumaric acid-modified rosin is preferably 40° C. to 90° C., more preferably 45° C. to 85° C., and still more preferably 50° C. to 80° C. from the perspective of improving the storage stability of the resulting polyester resin.

Note that the glass transition temperature of the fumaric acid-modified rosin can be measured, for example, by the method described hereinbelow in EXAMPLES.

The method of producing the fumaric acid-modified rosin is not particularly limited and may be suitably selected in accordance with the intended use. For example, a rosin and a fumaric acid are mixed together, the mixture is heated at a temperature of about 180° C. to about 260° C., and through Diels-Alder reaction, the fumaric acid is addition-reacted with acids having conjugated double bonds, contained in the rosin, thereby a fumaric acid-modified rosin can be obtained.

Further, from the perspective of efficiently reacting rosin with fumaric acid, the reaction is preferably carried out in the presence of phenols. As the phenols, preferred are divalent phenols, and phenol compounds having a substituent at the ortho position thereof (called hindered phenols, hereinafter). Of these phenols, hindered phenols are particularly preferable.

The divalent phenol means a compound having a structure where two OH groups are bonded to a benzene ring, having no other substituents. Among such divalent phenols, hydroquinone is preferable.

The hindered phenol is not particularly limited and may be suitably selected in accordance with the intended use. Examples thereof include mono-t-butyl-p-cresol, mono-t-butyl-m-cresol, t-butyl catechol, 2,5-di-t-butylhydroquinone, 2, 5-di-t-amylhydroquinone, propyl gallate, 4,4′-methylenebis(2,6-t-butylphenol), 4,4′-isopropylenebis(2,6-di-t-butylphenol), 4,4′-butylidenebis(3-methyl-6-t-butylphenol), butylhydroxyanisole, 2,6-di-t-butyl-p-cresol, 2,6-di-t-butylphenol, 2,6-di-t-butyl-4-ethylphenol, 2,4,6-tri-t-butylphenol, octadecyl-3-(4-hydroxy3′,5′-di-t-butylphenyl)propyonate, distearyl(4-hydroxy-3-methyl-5-t-butyl)benzyl malonate, 6-(4-hydroxy3,5-di-t-butylanilino)2,4-bis-octylthio-1,3,5-triadine, 2,6-diphnyl-4-octadecanoxyphenol, 2,2′-methylenebis(4-methyl-6-t-butylphenol), 2,2′-methylenebis(4-ethyl-6-t-butylphenol), 2,2′-isobutylidenebis(4,6-dimethylphenol), 2,2′-dihydroxy-3,3′-di(α-methylcyclohexyl)-5,5′-dimethyldiphenylmethane, 2,2′-methylenebis(4-methyl-6-cyclohexylphenol), tris[β-(3,5-di-t-butyl-4-hydroxyphenyl)proprionyloxyethyl]isocyanurate, 1,3,5-tris(2,6-dimethyl-3-hydroxy4-t-butylbenzyl)isocyanurate, tris(3,5-di-t-butyl-4-hydroxyphenol)isocyanurate, 1,1,3′-tris(2-methyl-4-hydroxy-5-t-butylphenyl)butane, 2,6-bis(2′-hydroxy-3′-t-butyl-5′-methylbenzyl)-4-methylphenol, N,N′-hexamethylenebis(3,5-di-t-butyl-4-hydoxyhydrocinnamate), hexamethyleneglycolbis[β-(3,5-di-t-butyl-4-hydroxyphenyl)propionate], triethylene glycol bis[β-(3-t-butyl-5-methyl-4-hydroxyphenyl)propionate], and tetrakis[methylene-3-(3,5-di-t-butyl-4-hydroxyphenyl)propionate]methane. Among these, t-butyl catechol is particularly preferable.

The amount of use of the phenols is preferably 0.001 parts by mass to 0.5 parts by mass, more preferably 0.003 parts by mass to 0.1 parts by mass, and still more preferably 0.005 parts by mass to 0.1 parts by mass with respect to 100 parts by mass of a starting material monomer of the fumaric acid-modified rosin.

The fumaric acid-modified rosin may be directly used, or may be or further purified through distillation or the like before use.

As for a rosin used in the fumaric acid-modified rosin, any rosin may be employed without particularly limiting to known rosins, as long as it is a rosin containing abietic acid, neoabietic acid, palustric acid, pimaric acid, isopimaric acid, sandaracopimaric acid, dehydroabietic acid, and levopimaric acid as main components, such as a natural rosin obtained from pine trees, an isomerized rosin, a dimerized rosin, a polymerized rosin, and a disproportionated rosin. From the perspective of color, preferred are natural rosins such as tall rosins derived from tall oils which are obtained as by-product in production process of natural rosin pulp; gum rosins derived from crude turpentine; and wood rosins obtained from pine stubs. From the perspective of low-temperature fixability, tall rosins are more preferable.

The fumaric acid-modified rosin is obtained through Diels-Alder reaction under heating, and thus it contains in a reduced amount impurities causing unpleasant odor and has less odor. From the perspective of further reducing odor and improving storage stability, the fumaric acid -modified rosin is preferably obtained by modification of a purified rosin with fumaric acid, and more preferably obtained by modification of a purified tall rosin with fumaric acid.

The amount of the fumaric acid-modified rosin contained in the carboxylic acid component is preferably 5% by mass or more, more preferably 8% by mass or more, and still more preferably 10% by mass or more, from the viewpoint of low-temperature fixability. From the viewpoint of storage stability, it is preferably 85% by mass or less, more preferably 70% by mass or less, still more preferably 60% by mass or less, and particularly preferably 50% by mass or less. From these viewpoints, the amount of the fumaric acid-modified rosin contained in the carboxylic acid component is preferably 5% by mass to 85% by mass, more preferably 5% by mass to 70% by mass, still more preferably 8% by mass to 60% by mass, and particularly preferably 10% by mass to 50% by mass.

### <Maleic Acid-Modified Rosin>

Since conventionally used rosins are monovalent, the rosin content in the resulting polyester resin cannot be increased. Meanwhile, when a modified rosin obtained by reacting with a conventional polyhydric alcohol is used, the content concentration of rosin in the resulting polyester resin can be increased. It is, however, inferior in reactivity of polycondensation reaction because it is used as an alcohol component, the low-temperature fixability of the resulting polyester resin is inadequate, and the storage stability is liable to degrade due to the large amount of rosin contained therein.

In contrast, the polyester resin (A) for use in the present invention uses a maleic acid-modified rosin, which is obtained by reaction (Diels-Alder reaction) of a rosin having a conjugated diene with a maleic acid or derivative thereof (dienophile) as one of carboxylic acid component, and is obtained by polycondensation of the rosin with an alcohol component containing a divalent aliphatic alcohol in a specific amount. Thus, the low-temperature fixability further improves while increasing the rosin content.

Also, since a polyester resin using a divalent aliphatic alcohol has a flexible skeleton, the polyester resin has a low-glass transition temperature, and thus adequate effect of storage stability has not been obtained. However, through use of a combination of such a polyester resin with a maleic acid-modified rosin of the present invention, i.e., a specific modified rosin having an aromatic skeleton, the reactivity of polycondensation reaction is increased to raise the glass transition temperature. Therefore, the storage stability of the resulting toner can be improved, although rosin is used. Moreover, a polyester resin obtained by using a conventional divalent aliphatic alcohol is excellent in fixability, but has a disadvantage in environmental stability because it easily absorbs moisture, and when used to prepare a toner, the chargeability of the toner is readily affected by environmental conditions, leading to variations in image density. However, in the present invention, the environmental stability can be improved while ensuring the fixability of the toner by use of a combination of a divalent aliphatic alcohol and a maleic acid-modified rosin.

The maleic acid-modified rosin can be obtained by addition-reacting a rosin containing, for example, abietic acid, neoabietic acid, palustric acid, pimaric acid, isopimaric acid, sandaracopimaric acid, dehydroabietic acid, and levopimaric acid as main components, with a maleic acid or maleic anhydride. More specifically, the maleic acid-modified rosin can be obtained by Diels-Alder reaction of levopimaric acid, abietic acid, neoabietic acid and palustric acid each of which have a conjugated double bond in main components of a rosin, with a maleic acid or maleic acid derivative (maleic anhydride, maleic acid ester etc.), under heating.

The degree of modification of rosin with the maleic acid or derivative thereof (maleic anhydride, maleic acid ester etc.) is preferably 30 to 105, more preferably 40 to 105, still more preferably 50 to 105, particularly preferably 60 to 105, and most preferably 70 to 105. When the degree of modification with maleic acid (maleic acid-modified degree) is less than 30, it may be impossible to increase the molecular weight of the resulting polyester resin and reduce the amount of oligomer components having low-molecular weight. When the maleic acid-modified degree is more than 105, the melt viscosity of the resulting modified rosin is increased, and there is concern that the productivity of polyester resin will degrade.

The degree of modification of rosin with maleic acid can be calculated by the following Equation (3):

Degree of modification of rosin with maleic acid=[(X₁−Y)/(X₂−Y)]×100 Equation (3)

In Equation (3), X₁ denotes an SP value of a maleic acid-modified rosin whose modification degree is to be calculated, X₂ denotes a saturated SP value of a maleic acid-modified rosin obtained by reacting 1 mol of maleic acid or derivative thereof with 1 mol of a rosin having a conjugated diene at 230° C., and Y denotes an SP value of the rosin having a conjugated diene. The individual SP values are measured in accordance with the following manner.

### —Measurement of SP Value—

Each sample in a molten state in an amount of 2.1 g is flowed into a given ring, cooled to room temperature, and then measured according to the following conditions, based on the method described in JIS B7410.

Measurement device: automatic ring and ball softening point tester (ASP-MGK2, manufactured by Meitech Co., Ltd.)

Temperature raising rate: 5° C./min

Start temperature of temperature rise: 40° C.

Solvent use in measurement: glycerin

In other words, the SP value means a softening point measured by an automatic ring and ball softening point tester, as described hereinbelow in EXAMPLES. In Equation (3), the numerator (X₁−Y) means an increased degree of the SP value of the rosin that has been modified with maleic acid or maleic anhydride, and the greater the value of degree of modification of rosin with maleic acid or maleic anhydride, represented by Equation (3), the higher the modified degree is.

The method of producing the maleic acid-modified rosin is not particularly limited and may be suitably selected in accordance with the intended use. For example, a rosin and a maleic acid or maleic anhydride are mixed together, the mixture is heated at a temperature of about 180° C. to about 260° C., and through Diels-Alder reaction, the maleic acid or maleic anhydride is addition-reacted with acids having conjugated double bonds, contained in the rosin, thereby a maleic acid-modified rosin can be obtained. The resulting maleic acid-modified rosin may be directly used, or may be further purified through distillation or the like before use.

As for a rosin used in the maleic acid-modified rosin, any rosin may be employed without particularly limiting to known rosins, as long as it is a rosin containing abietic acid, neoabietic acid, palustric acid, pimaric acid, isopimaric acid, sandaracopimaric acid, dehydroabietic acid, and levopimaric acid as main components, such as a natural rosin obtained from pine trees, an isomerized rosin, a dimerized rosin, a polymerized rosin, and a disproportionated rosin. From the perspective of color, preferred are natural rosins such as tall rosins derived from tall oils which are obtained as by-product in production process of natural rosin pulp; gum rosins derived from crude turpentine; and wood rosins obtained from pine stubs. From the perspective of low-temperature fixability, tall rosins are more preferable.

The maleic acid-modified rosin is obtained through Diels-Alder reaction under heating, and thus it contains in a reduced amount impurities causing unpleasant odor and has less odor. From the perspective of further reducing odor and improving storage stability, the maleic acid-modified rosin is preferably obtained by modification of a purified rosin with maleic acid or maleic anhydride, and more preferably obtained by modification of a purified tall rosin with maleic acid or maleic anhydride.

The amount of the maleic acid-modified rosin contained in the carboxylic acid component is preferably 15% by mass or more, and more preferably 25% by mass or more, from the viewpoint of low-temperature fixability. From the viewpoint of storage stability, it is preferably 85% by mass or less, more preferably 65% by mass or less, and still more preferably 50% by mass or less. From these viewpoints, the amount of the maleic acid-modified rosin contained in the carboxylic acid component is preferably 15% by mass to 85% by mass, more preferably 25% by mass to 65% by mass, and still more preferably 25% by mass to 50% by mass.

Carboxylic acid compounds other than the (meth)acrylic acid-modified rosin, fumaric acid-modified rosin and maleic acid-modified rosin, contained in the carboxylic acid component of the polyester resin (A) are not particularly limited and may be suitably selected in accordance with the intended use. Examples thereof include aliphatic dicarboxylic acids such as oxalic acid, malonic acid, citraconic acid, itaconic acid, glutaconic acid, succinic acid, adipic acid, sebacic acid, azelaic acid, n-dodecyl succinic acid; aromatic dicarboxylic acids such as phthalic acid, isophthalic acid and terephthalic acid; alicyclic dicarboxylic acids such as cyclohexane dicarboxylic acid; trivalent or higher polyhydric carboxylic acids such as trimellitic acid, and pyromellitic acid; anhydrides of these acids; and alkyl (having 1 to 3 carbon atoms) esters. In the present invention, the acids, anhydrides of these acids or alkyl esters of these acids are collectively called carboxylic acid compounds.

### —Polyester Resin (B)—

The binder resin for use in the present invention uses a polyester resin (B) in combination with the above-mentioned polyester resin (A). Effects derived from respective resins in the binder resin can synergistically work, and the effects of the present invention can be optimally exhibited only after these resins are used in combination.

The polyester resin (B) can be obtained by polycondensation of an alkylene oxide adduct of bisphenol A represented by the following General Formula (1) with a carboxylic acid.

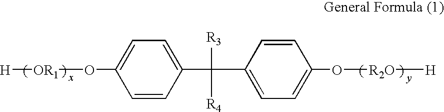

In General Formula (1), R₁ and R₂ are each an alkylene group having 2 to 4 carbon atoms, such as an ethylene group, and a propylene group; R₃ and R₄ are each any one of a hydrogen atom, a straight-chain alkyl group having 1 to 6 carbon atoms and a branched alkyl group having 1 to 6 carbon atoms, for example, a methyl group, an ethyl group, a propyl group, an isopropyl group, a butyl group, a t-butyl group, and a hexyl group are exemplified, and a hydrogen atom or a methyl group is particularly preferable; x and y are each a positive integer, the sum of x and y is 1 to 16, and particularly preferred is 2 to 6.

### —Alcohol Component—

As the alkylene oxide adduct of bisphenol A represented by General Formula (1), as an alcohol component of the polyester resin (B), for example, diols obtained by polymerization of a cyclic ether such as ethylene oxide and propylene oxide of bisphenol A, bisphenol F and the like are exemplified.

The alcohol component of the polyester resin (B) may contain alcohols other than the compound represented by General Formula (a) within the range where the object and interaction effects of the present invention are not impaired. The amount of the alkylene oxide adduct of bisphenol A represented by General Formula (1) contained in a divalent alcohol component is preferably 80 mole % or more.

### —Carboxylic Acid—

The carboxylic acid of the polyester resin (B) is not particularly limited and may be suitably selected in accordance with the intended use. Examples of the carboxylic acid of the polyester resin (B) include benzene dicarboxylic acids such as phthalic acid, isophthalic acid, and terephthalic acid or anhydrides thereof; alkyl dicarboxylic acids such as succinic acid, adipic acid, sebacic acid, and azelaic acid or anhydrides thereof; unsaturated dibasic acids such as maleic acid, citraconic acid, itaconic acid, alkenylsuccinic acid, fumaric acid, and mesaconic acid or anhydrides thereof; and unsaturated dibasic anhydrides such as maleic anhydride, citraconic anhydride, itaconic anhydride, and alkenylsuccinic anhydride. Examples of trivalent or higher polyhydric carboxylic acid include trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylene carboxypropane, tetra(methylenecarboxy)methane, 1,2,7,8-octanetetracarboxylic acid, Enpol trimer acid, or anhydrides thereof, and partially lower alkyl esters.

Among these, from the perspective of heat resistant storage stability and mechanical strength of the resin, the carboxylic acid component of the polyester resin (B) preferably contain an aromatic polyhydric carboxylic acid compound such as phthalic acid, isophthalic acid, terephthalic acid and trimellitic acid. The amount of the aromatic polyhydric carboxylic acid compound contained in the carboxylic acid component is preferably 40 mole % to 95 mole %, more preferably 50 mole % to 90 mole %, and still more preferably 60 mole % to 80 mole %.

### —Esterifying Catalyst—

It is preferable that the polycondensation of the alcohol components and the carboxylic acids of the polyester resin (A) and the polyester resin (B) be carried out in the presence of an esterifying catalyst.

Examples of the esterifying catalyst include Lewis acids such as p-toluene sulfonic acid; titanium compounds, and tin (II) compounds having no Sn—C bond. These esterifying catalysts are used alone or in combination of two of them. In the present invention, a titanium compound and/or a tin (II) compound having no Sn—C bond are preferably used.

As the titanium compound, preferred is a titanium compound having a Ti—O bond, and an alkoxy group, an alkenyloxy group or acyloxy group each of which have carbon atoms in total of 1 to 28 is more preferable.

Examples of the titanium compound include titanium diisopropylate bis-triethanolaminate [Ti(C₆H₁₄O₃N)₂(C₃H₇O)₂], titanium diisopropylate bis-diethanolaminate [Ti(C₄H₁₀O₂N)₂(C₃H₇O)₂], titaniumdipentylate-bis ethanolaminate [Ti(C₆H₁₄O₃N)₂(C₅H₁₁O)₂], titaniumdiethylate bis triethanolaminate [Ti(C₆H₁₄O₃N)₂(C₂H₅O)₂], titaniumdihydroxy octylate-bis triethanolaminate [Ti(C₆H₁₄O₃N)₂(OHC₈H₁₆O)₂], titaniumdistearate-bis triethanolaminate [Ti(C₆H₁₄O₃N)₂(C₁₈H₃₇O)₂], titanium triisopropylate triethanolaminate [Ti(C₆H₁₄O₃N)₁(C₃H₇O)₃], and titanium monopropylate tris(triethanolaminate) [Ti(C₆H₁₄O₃N)₃(C₃H₇O)₁]. Among these, titanium diisopropylate bis-triethanolaminate, titanium diisopropylate bis-diethanolaminate and titanium dipentylate-bis triethanolaminate are preferable, and these compounds are available as commercial products from Matsumoto Trading Co., Ltd.

Specific examples of other preferred titanium compounds include, but not limited to, tetra-n-butyltitanate [Ti(C₄H₉O)₄], tetrapropyl titanate [Ti(C₃H₇O)₄], tetrastearyl titanate [Ti(C₁₈H₃₇O)₄], tetra tetramyristyl titanate [Ti(C₁₄H₂₉O)₄], tetraoctyl titanate [Ti(CsH₁₇O)₄], dioctyl dihydroxy octyl titanate [Ti(C₈H₁₇O)₂(OHC₈H₁₆O)₂], and dimyristyl dioctyltitanate [Ti(C₁₄H₂₉O)₂(C₈H₁₇O)₂]. Among these, preferred are tetrastearyl titanate, tetramyristyl titanate, tetraoctyl titanate, and dioctyl dihydroxyoctyl titanate. These can be obtained by reacting a hydrogenated titanium with the corresponding alcohol or are available from Nisso Co. Ltd. as commercial products.

The amount of the titanium compound present relative to 100 parts by mass of the total amount of the alcohol components and the carboxylic components is preferably 0.01 parts by mass to 1.0 part by mass, and more preferably 0.1 parts by mass to 0.7 parts by mass.

As the tin (II) compound having no Sn—C bond, preferred are a tin (II) compound having an Sn—O bond, a tin (II) compound having an Sn—X (where X represents a halogen atom) bond, and the like; and a tin (II) compound having an Sn—O bond is more preferable.

Examples of the tin (II) compound having an Sn—O bond include, for example, tin (II) carboxylates having carboxylic acid groups with 2 to 28 carbon atoms, such as tin (II) oxalate, tin (II) diacetate, tin (II) dioctanoate, tin (II) dilaurate, tin (II) distearate, and tin (II) dioleate; dialkoxy tin (II) having alkoxy groups with 2 to 28 carbon atoms, such as dioctyloxy tin (II), dilauryoxy tin (II), distearoxy tin (II), and dioleyloxy tin (II); tin (II) oxides; and tin (II) sulfates. Examples of the tin (II) compound having an Sn—X (where X represents a halogen atom) bond include halogenated tin (II) such as tin (II) chlorides, tin (II) bromides. Among these, in terms of charge start-up characteristics and catalytic capacity, fatty acid tin (II) represented by (R¹COO)₂Sn (where R¹ represents an alkyl group or alkenyl group having 5 to 19 carbon atoms), dialkoxy tin (II) represented by (R²O)₂Sn (where R² represents an alkyl group or alkenyl group having 6 to 20 carbon atoms), and tin (II) oxides represented by SnO are preferable; fatty acid tin (II) represented by (R¹COO)₂Sn and tin (II) oxides being more preferable; and tin (II) dioctanoate, tin (II) distearate and tin (II) oxides are still more preferable.

The amount of the tin (II) compound present relative to 100 parts by mass of the total amount of the alcohol components and the carboxylic acid components is preferably 0.01 parts by mass to 1.0 part by mass, and more preferably 0.1 parts by mass to 0.7 parts by mass.

When a combination of the titanium compound and the tin (II) compound, the total amount of the titanium compound and the tin (II) compound present relative to 100 parts by mass of the total amount of the alcohol components and the carboxylic acid components is preferably 0.01 parts by mass to 1.0 part by mass, and more preferably 0.1 parts by mass to 0.7 parts by mass.

The polycondensation of the alcohol components and the carboxylic acid components can be carried out, for example, in the presence of the esterifying catalyst, in an inactive gas atmosphere at a temperature of 180° C. to 250° C.

The toner of the present invention can achieve excellent low-temperature fixability, hot offset resistance and heat resistant storage stability, reduce occurrence of odor and is excellent in smear resistance on developing roller etc. in a super high-speed system and productivity only after using the polyester resin (A) and the polyester resin (B) which satisfy the above-mentioned conditions. With this, it is possible to provide a developer using toner. It is considered that because a polyester resin (B) having a bisphenol A skeleton which has high-mechanical strength is dispersed in a micro-phase separated state in a polyester resin (A) containing an aliphatic polyhydric alcohol which is excellent in dispersibility of releasing agent, the toner of the present invention can improve the heat resistant storage stability and smear resistance on developing roller etc. by the effect of the polyester resin (B) having a bisphenol A skeleton which has high-mechanical strength, while taking advantage of the excellent fixability and pulverizability of the polyester resin (A) which can be obtained by polycondensation of an alcohol component containing an aliphatic polyhydric alcohol with a carboxylic acid component containing a (meth)acrylic acid-modified rosin.

Therefore, by only using a binder resin provided with both an aliphatic alcohol skeleton and a bisphenol skeleton in one molecule, it is impossible to obtain the interaction effects of the present invention attributable to the use of the polyester resin (A) and the polyester resin (B).

When the carboxylic acid component containing a modified rosin is used, a mass ratio [(B)/(A)] of the polyester resin (B) to the polyester resin (A) is preferably 1/9 to 6/4, and more preferably 3/7 to 5/5.

The mass ratio [(B)/(A)] is less than 1/9, the heat resistant storage stability and offset resistance may degrade, and when it is more than 6/4, the low-temperature fixability may degrade.

Here, the carboxylic acid component containing a modified rosin means a carboxylic acid component containing a purified or unpurified rosin which has been modified with any one of a (meth)acrylic acid, a fumaric acid and a maleic acid. In the meanwhile, when referred to as “a purified rosin” simply, it means “a purified rosin which has not been modified”.

When the carboxylic acid component containing a purified rosin is used, the mass ratio [(B)/(A)] of the polyester resin (B) to the polyester resin (A) is 2/8 to 6/4, and preferably 3/7 to 5/5.

When the mass ratio [(B)/(A)] is less than 2/8, the offset resistance and heat resistant storage stability and may degrade, and when it is more than 6/4, the low-temperature fixability may degrade.

The glass transition temperature of the polyester resin (A) and the polyester resin (B) is preferably 45° C. to 75° C., and more preferably 50° C. to 70° C. from the perspective of fixability, heat resistant storage stability and durability.

A softening point Tm(B) of the polyester resin (B) is preferably 80° C. to 160° C., more preferably 80° C. to 120° C., still more preferably 85° C. to 115° C., and particularly preferably 90° C. to 110° C.

Also, from the perspective of the low-temperature fixability, offset resistance and heat resistant storage stability, the amount of a low-molecular-weight component having a molecular weight of 500 or less, which is derived from residual monomer components and oligomer components, contained in the polyester resin (A) is preferably 12% or less, more preferably 10% or less, still more preferably 9% or less, and particularly preferably 8% or less. Note that the amount of the low-molecular-weight component is determined by the area of a molecular weight measured by the after-mentioned Gel Permeation Chromatography (GPC).

The acid value of the polyester resin (A) and the polyester resin (B) is preferably 1 mgKOH/g to 70 mgKOH/g.

The dispersed state of the resins and releasing agent becomes optimum at the time when the acid value of the polyester resin (A) is in a range of 25 mgKOH/g to 70 mgKOH/g and the acid value of the polyester resin (B) is in a range of 1 mgKOH/g to 25 mgKOH/g.

Note that in the present invention, the term “polyester resin” is a resin having a polyester unit. The polyester unit means a region having a polyester structure, and includes not only polyesters but also include polyesters which are modified to such an extent that characteristics thereof are not substantially impaired, however, in the present invention, it is preferably that both of the polyester resins (A) and (B) be a modified polyester. Examples of modified polyesters include, for example, polyesters which are grafted or blocked with phenol, urethane, epoxy resin or the like by the method described in Japanese Patent Application Laid-Open (JP-A) Nos. 11-133668, 10-239903, 08-20636 and the like, and composite resins having two or more resin units including a polyester unit.

In the present invention, the polyester resin (A) and the polyester resin (B) are preferably amorphous resins differing from crystalline resins. In this specification, an amorphous resin means a resin having a difference in temperature of 30° C. or higher between its softening point and its glass transition temperature (Tg).

Note that in the present invention, the binder resin may contain other resins other than the polyester resin (A) and the polyester resin (B) within a range where the effects of the present invention are not impaired.

As the other resins, in addition to polyester resins, known binder resins, for example, a vinyl resin such as a styrene-acrylic resin, an epoxy resin, polycarbonate, polyurethane, a composite resin (otherwise referred to as “hybrid resin”) having two or more resin units including a polyester unit may be used in combination.

### <Colorant>

The colorant used in the present invention is not particularly limited and may be suitably selected from among commonly used resins. Examples of the colorant include carbon black; Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, colcothar, red lead oxide, orange lead, cadmium red, cadmium mercury red, antimony orange, Permanent Red 4R, Para Red, Fire Red, para-chloro-ortho-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, phthalocyanine green, anthraquinone green, titanium oxide, zinc oxide, and lithopone. These colorants may be used alone or in combination.

Color of the colorant is not particularly limited and may be suitably selected in accordance with the intended use. For example, colorants for black toner, and colorants for color toner are exemplified. These colorants may be used alone or in combination.

Examples of colorants for black toner include carbon blacks (C.I. Pigment Black 7) such as furnace black, lamp black, acetylene black, and channel black; metals such as copper and iron (C.I. Pigment Black 11), and titanium oxides; and organic pigments such as aniline black (C.I. Pigment Black 1).

Examples of colorants for magenta color toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209, and 211; and C.I. Pigment Violet 19; C.I. Vat Red 1, 2, 10, 13, 15, 23, 29, and 35.

Examples of colorants for cyan color toner include C.I.

Pigment Blue 2, 3, 15, 15:1, 15:2, 15:3, 15:4, 15:6, 16, 17, and 60; C.I. Vat Blue 6; C.I. Acid Blue 45 or copper-phthalocyanine whose phthalocyanine skeleton has been substituted with 1 to 5 phthalimide methyl groups, Green 7, and Green 36.

Examples of colorants for yellow color toner include C.I Pigment Yellow 0-16, 1, 2, 3, 4, 5, 6, 7, 10, 11, 12, 13, 14, 15, 16, 17, 23, 55, 65, 73, 74, 83, 97, 110, 151, 154, and 180; C.I. Vat Yellow 1, 3, and 20, and Orange 36.

The amount of the colorant contained in the toner is not particularly limited and may be suitably selected in accordance with the intended use. It is preferably 1% by mass to 15% by mass, and more preferably 3% by mass to 10% by mass. When the amount of the colorant is less than 1% by mass, reduction of tinting strength is observed, and when it is more than 15% by mass, dispersion defect of the pigment occurs in the toner, possibly leading to degradation of tinting strength, and degradation of electric properties of the toner.

The colorant may be combined with a resin for use as a masterbatch. The resin is not particularly limited and may be suitably selected from among known resins in accordance with the intended use. Examples of the resin include styrenes and polymers of the substitution product thereof, styrene copolymers, polymethylmethacrylate resins, polybutylmethacrylate resins, polyvinyl chloride resins, polyvinyl acetate resins, polyethylene resins, polypropylene resins, polyesters, epoxy resins, epoxy polyol resins, polyurethane resins, polyamide resins, polyvinyl butyral resins, polyacrylate resins, rosins, modified rosins, terpene resins, aliphatic or alicyclic hydrocarbon resins, polycyclic hydrocarbon resins, aromatic petroleum resins, chlorinated paraffin, and paraffin wax. These may be used alone or in combination.

Examples of styrenes or polymers of the substitution product thereof include polyester resins, polystyrene, poly(p-chlorostyrene) and polyvinyltoluene. Examples of styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-chloromethyl methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleate copolymers.

The masterbatch can be obtained by mixing and kneading the resin for masterbatch and the colorant under application of high shearing force. On that occasion, it is preferable to add an organic solvent to a mixture of the colorant and the resin so as to enhance the interaction between the colorant and the resin. A so-called flashing method, where an aqueous paste containing colorant water is mixed and kneaded with a resin and an organic solvent to transfer the colorant to the resin, and water content and organic solvent component are removed, may also be preferably used because a wet cake of the colorant may be directly used without drying the cake. For the mixing and kneading, a high-shearing dispersion apparatus such as a triple roll mill is preferably used.

### <Charge Controlling Agent>

The charge controlling agent is not particularly limited and may be suitably selected from known charge controlling agents in accordance with the intended use. When a colored material is used, the resulting toner may change in color. Thus, a colorless material and/or material of color close to white is preferably used. Examples of the charge controlling agent include, but not limited to, triphenylmethane dyes, molybdic acid chelate pigments, rhodamine dyes, alkoxy-based amines, quaternary ammonium salts (including fluorine-modified quaternary ammonium salt), alkylamides, a single substance of phosphorus or compound thereof, a single substance of tungsten or compound thereof, fluorochemical surfactants, salicylic acid metal salts, and metal salts of salicylic acid derivatives. These may be used alone of in combination.

For the charge controlling agent, commercially available products may be used. Specific examples of the commercially available products include BONTRON P-51 of a quaternary ammonium salt, E-82 of an oxynaphthoic acid-based metal complex, E-84 of a salicylic acid-based metal complex, and E-89 of a phenolic condensate (produced by ORIENT CHEMICAL Co. Ltd.); TP-302 and TP-415 of a quaternary ammonium salt molybdenum complex (produced by HODOGAYA CHEMICAL Co., Ltd.); COPY CHARGE PSY VP2038 of a quaternary ammonium salt, COPY BLUE PR of a triphenyl methane derivative, COPY CHARGE NEG VP2036 of a quaternary ammonium salt, and COPY CHARGE NX VP434 (produced by Hoechst AG); LRA-901 and LR-147 of a boron complex (produced by NIPPON CARLIT Co., Ltd.); quinacridone, azo pigments, and other polymer compounds having a functional group such as sulfonic group, carboxyl group, quaternary ammonium salt or the like. These may be used alone or in combination.

The charge controlling agent may be melt-kneaded together with the masterbatch before being dissolved and/or dispersed, or may be directly added along with respective components of the toner to the organic solvent when the components are dissolved and/or dispersed therein, or may be fixed on a surface of toner after toner particles are produced.

The amount of the charge controlling agent contained in the toner differs depending on the type of the binder resin used, presence or absence of additives, and a dispersion method employed, and is not unequivocally defined. However, for example, it is preferably 0.1 parts by mass to 10 parts by mass, and more preferably 0.2 parts by mass to 5 parts by mass.

When the amount of the charge controlling agent is less than 0.1 parts by mass, sufficient charge controlling property may not be obtained. When it is more than 10 parts by mass, the effect of the primary charge controlling agent is impaired due to excessively high chargeability of the toner to increase the electrostatic attraction force to a developing roller, possibly leading to degradation in flowability of the toner and degradation in image density.

### <Releasing Agent>

The releasing agent is not particularly limited and may be suitably selected from among known releasing agents in accordance with the intended use. Examples of the releasing agent include waxes such as carbonyl group-containing wax, polyolefine wax, and long-chain hydrocarbon. These may be used alone or in combination. Among these, carbonyl group-containing waxes are preferably used.

Examples of the carbonyl group-containing wax include polyalkanoic acid esters, polyalkanol esters, polyalkanoic acid amides, polyalkylamides, and dialkyl ketones. These may be used alone or in combination. Among these carbonyl group-containing waxes, polyalkanoic acid esters are preferably used.

Examples of the polyalkanoic acid esters include carnauba wax, montan wax, trimethylolpropane tribehenate, pentaerythritol tetrabehenate, pentaerythritol diacetate dibehenate, glycerin tribehenate, and 1,18-octadecanediol distearate. Examples of the polyalkanol esters include tristearyl trimellitate and distearyl maleate. Examples of the polyalkanoic acid amides include ethylenediamine dibehenyl amide. Examples of the polyalkylamides include tristearylamide trimellitate. Examples of the dialkyl ketones include distearyl ketone. Among these carbonyl group-containing waxes, polyalkanoic acid esters are particularly preferable.

Examples of the polyolefin waxes include polyethylene waxes, and polypropylene waxes.

Examples of the long-chain hydrocarbon include parafin wax, and Sazol wax.

The melting point of the releasing agent is not particularly limited and may be suitably adjusted in accordance with the intended use. It is preferably 40° C. to 160° C., more preferably 50° C. to 120° C., and particularly preferably 60° C. to 90° C. When the melting point is lower than 40° C., it may adversely affect the heat resistant storage stability, and when it is higher than 160° C., cold offset may easily occur at the time of fixing at low-temperatures.

The melting point of the releasing agent can be determined as follows. A releasing agent sample is heated to 200° C. and cooled from the temperature to 0° C. at a temperature decreasing rate of 10° C./min, then heating at a temperature raising rate of 10° C./min, and a maximum peak temperature of heat of melting measured using a differential scanning calorimeter (DSC210, manufactured by Seiko Instruments Inc.) can be determined as the melting point of the sample.

The melt viscosity of the releasing agent is preferably, as a value measured at a temperature 20° C. higher than the melting point of the wax, 5 cps to 1,000 cps, and more preferably 10 cps to 100 cps.

When the melt viscosity is lower than 5 cps, the releasing property may degrade, and when it is higher than 1,000 cps, the effect of improving the hot offset resistance and low-temperature fixability may not be obtained.

The amount of the releasing agent contained in the toner is not particularly limited and may be suitably adjusted in accordance with the intended use. It is preferably 40% by mass or less, and more preferably 3% by mass to 30% by mass. When the amount of the releasing agent is more than 40% by mass, the flowability of the resulting toner may degrade.

### —External Additive—

The external additive is not particularly limited and may be suitably selected from among known additives in accordance with the intended use. Preferred examples thereof include silica fine particles, hydrophobized silica, fatty acid metal salts (e.g. zinc stearate, aluminum stearate, etc.); metal oxides (e.g. titania, alumina, tin oxide, antimony oxide, etc.); and fluoropolymers. Among these, there may be exemplified a hydrophobized silica fine particle, a hydrophobized titania fine particle, a hydrophobized titanium oxide fine particle, and a hydrophobized alumina fine particle.

Specific examples of the silica fine particle include HDK H 2000, HDK H 2000/4, HDK H 2050EP, HVK21, and HDK H1303 (all produced by Hoechst AG); R972, R974, RX200, RY200, R202, R805, and R812 (all produced by Japan AEROSIL Inc.). Specific examples of the titania fine particle include P-25 (produced by Japan AEROSIL Inc.), STT-30 and STT-65C-S (produced by Titan Kogyo Ltd.), TAF-140(produced by Fuji Titanium Industry Co., Ltd.), MT-150W, MT-500B, MT-600B, and MT-150A (all produced by TAYCA CORPORATION). Examples of the hydrophobized titan oxide include T-805 (produced by Japan AEROSIL Inc.); STT-30A and STT-65S-S (produced by Titan Kogyo Ltd.); TAF-500T and TAF-1500T (produced by Fuji titanium Industry Co., Ltd.); MT-100S and MT-100T (produced by TAYCA CORPORATION); and IT-S (Ishihara Sangyo Kaisha Ltd.).

The hydrophobized oxide fine particle, hydrophobized silica fine particle, hydrophobized titania fine particle, and hydrophobized alumina fine particle can be obtained by surface treating a hydrophilic fine particle with a silane coupling agent such as methyl trimethoxy silane, methyl triethoxy silane, octyl trimethoxy silane or the like. Also, a silicone oil-treated oxide fine particle obtained by surface treating an inorganic fine particle with silicone oil under application of heat as necessary or inorganic fine particle are favorably used.

As the silicone oil, for example, dimethyl silicone oil, methylphenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy polyether-modified silicone oil, phenol-modified silicone oil, carboxyl-modified silicone oil, mercapto-modified silicone oil, acrylic or methacrylic-modified silicone oil, and a-methylstyrene-modified silicone oil and the like can be used.

Specific examples of the inorganic fine particles include silica, alumina, titanium oxide, barium titanate, magnesium titanate, calcium titanate, strontium titanate, iron oxide, copper oxide, zinc oxide, tin oxide, silica sand, clay, mica, wollastonite, diatom earth, chromium oxide, cerium oxide, colcothar, antimony trioxide, magnesium oxide, zirconium oxide, barium sulfate, barium carbonate, calcium carbonate, silicon carbide, and silicon nitride. Among these, silica and titanium dioxide are particularly preferable.

The amount of the external additive added to the toner is preferably 0.1% by mass to 5% by mass, and more preferably 0.3% by mass to 3% by mass.

The average primary particle diameter of the inorganic fine particle is preferably 100 nm or less, and more preferably 3 nm to 70 nm. When the average primary particle diameter of the inorganic fine particle is smaller than the range described above, the inorganic fine particle is embedded in the toner, and the function thereof is hardly effectively exerted.

When it is larger than the range, unfavorably, the inorganic fine particle uniformly damages a surface of a latent electrostatic image bearing member. As the external additive, an inorganic fine particle can be used in combination with a hydrophobized inorganic fine particle, and the average primary particle diameter of the hydrophobized inorganic fine particle is preferably 1 nm to 100 nm. In particular, the external additive preferably contains at least two types of hydrophobized inorganic fine particles having an average primary particle diameter of 5 nm to 70 nm. Still more preferably, the external additive contains at least two types of hydrophobized inorganic fine particles having an average primary particle diameter of 20 nm or smaller and at least one hydrophobized inorganic fine particle having an average primary particle diameter of 30 nm or larger. Also, it is preferable that the specific surface area of the inorganic fine particles measured by BET method be 20 m²/g to 500 m²/g.

Examples of a surface treatment agent of the external additive containing the oxide fine particles include silane coupling agents, such as dialkyl dihalogenated silane, trialkyl halogenated silane, alkyl trihalogenated silane, hexaalkyl disilazane; silylation agents, silane coupling agents having a fluorinated alkyl group, organic titanate coupling agents, aluminum coupling agents, silicone oils, and silicone varnishes.

A resin fine particle can also be added as the external additive. Examples of the resin fine particle include polystyrene obtained by soap-free emulsification polymerization, suspension polymerization or dispersion polymerization; copolymers of methacrylic acid ester and acrylic acid ester; polycondensation fine particles such as silicones, benzoguanamine, and nylon; and polymer particles of thermosetting resins. By using such resin fine particle in combination with inorganic fine particles, it is possible to strengthen the chargeability of the toner, to reduce the amount of oppositely charged toner and to reduce the occurrence of background smear. The amount of the resin fine particle added to the toner is preferably 0.01% by mass to 5% by mass, and more preferably 0.1% by mass to 2% by mass.

### <Other Components>

The other components are not particularly limited and may be suitably selected in accordance with the intended use. Examples thereof include, for example, a flowability improver, a cleanability improver, a magnetic material, and a metal soap.

The flowability improver increases hydrophobicity by a surface treatment, can prevent degradation of flow characteristics or charging characteristics even at a high humidity, and includes, for example, a silane coupling agent, a silylation agent, a silane coupling agent having a fluorinated alkyl group, an organic titanate-based coupling agent, an aluminum-based coupling agent, a silicone oil, a modified silicone oil, and so forth.

The cleanability improver is added to the toner in order to remove an untransferred developer, remaining on a latent electrostatic image bearing member and an intermediate transfer member, and examples thereof include, for example, fatty acid metal salts such as zinc stearate, calcium stearate, and stearic acid; and polymer fine particles produced by soap-free emulsification polymerization, such as a polymethyl methacrylate fine particle and a polystyrene fine particle. As the polymer fine particle, a polymer fine particle having a relatively narrow particle size distribution and a mass average particle diameter of 0.01 μm to 1 μm is preferably used.

The magnetic material is not particularly limited and may be suitably selected from among known magnetic materials in accordance with the intended use. Examples thereof include, for example, iron powder, magnetite and ferrite. Among these, white color materials are preferably used in terms of color tone.

### <Method for Producing Toner>

The method for producing a toner of the present invention is not particularly limited and hitherto known methods such as kneading/pulverizing method, polymerization method, dissolution suspension method, spray granulation method can be employed, however, in terms that the effects of the present invention can be efficiently exerted, kneading/pulverizing method is preferably employed.

The kneading/pulverization method is, for example, a method of melt-kneading toner materials containing at least a binder resin, a releasing agent, and a colorant, and pulverizing and classifying the kneaded product thus obtained, to produce toner base particles of the toner.

In the melt-kneading, the toner materials are mixed, and the mixture is put into a melting kneader. The melting kneader may be one-shaft or two-shaft continuous kneaders or batch kneaders with roll mills. Preferable examples thereof include KTK type two-shaft extruder (by Kobe Steel, Ltd.), TEM type extruder (by Toshiba Machine Co.), two-shaft extruder (by KCK Co.), PCM type two-shaft extruder (by Ikegai Ltd.), and Co-kneader (by Buss Co.). It is important that the melt-kneading step is carried out under appropriate conditions in which molecular chains of binder resins are not cut. Specifically, the melt-kneading temperature is adjusted in consideration of the softening point of the binder resin. When the temperature is excessively higher than the softening point, molecular chains of binder resins are severely cut. When the temperature is excessively low, toner materials may not be sufficiently dispersed.

In the pulverizing, the kneaded product obtained from the kneading step is pulverized. In the pulverizing, preferably the kneaded product is coarsely pulverized then finely pulverized. Examples of preferred pulverizing methods include a method of making the materials collide with a plate by means of jet air, a method of making particles collide each other by means of jet air, and a method of pulverizing by use of a narrow gap between mechanically rotating rotors and stators.

In the classifying, the pulverized product obtained from the pulverizing is classified so as to obtain particles of a predetermined particle diameter. The classifying may be carried out by removing a part of the particles that are finer than a desired size by, for example, a cyclone, a decanter, or a centrifuge.

After the pulverizing and classifying, the pulverized product is classified in an air flow by use of centrifugal force, to thereby produce toner base particles having a predetermined particle diameter.

Next, external additives are externally added to the toner base particle. While being broken and pulverized, the external additives are applied to a surface of the toner base particles by mixing and stirring the toner base particles and the external additives using a mixer. In this process, it is important to attach uniformly and tightly the external additives such as fine inorganic particles and fine resin particles to the toner base particles, in terms of enhancement of durability.

The mass average particle diameter of the toner is not particularly limited and may be suitably adjusted in accordance with the intended use. Here, the mass average particle diameter of the toner can be determined in accordance with the following manner.

Measurement device: COULTER MULTISIZER II (manufactured by Beckman Coulter Co.)

Aperture diameter: 100 μm

Analyzing software: COULTER MULTISIZER ACCUCOMP VER. 1.19 (manufactured by Beckman Coulter Co.)

Electrolytic solution: “Isotone II” (manufactured by Beckman Coulter Co.)

Dispersion liquid: A 5% electrolytic solution of “EMULGEN 109P” (manufactured by Kao Corporation, polyoxyethylene lauryl ether, HLB: 13.6)

Dispersion Conditions: Ten milligrams of a test sample is added to 5 ml of the dispersion liquid, and the resulting mixture is dispersed in an ultrasonic dispersing device for 1 minute. Thereafter, 25 ml of the electrolytic solution is added to the dispersion liquid, and the resulting mixture is dispersed in the ultrasonic dispersing device for another 1 minute.

Measurement Conditions: One-hundred milliliters of the electrolytic solution and the dispersion liquid are added to a beaker, and the particle sizes of 30,000 particles are determined under the conditions for concentration satisfying that the determination for 30,000 particles are completed in 20 seconds. The mass average particle diameter is obtained from the particle size distribution.

### (Developer)

The toner of the present invention may be used as a developer which contains at least the toner and suitably selected other components such as a carrier. The developer may be a one-component developer or two-component developer. When the developer is used in a super high-speed image forming system having functions responsive to recent print on demand (POD) technology, it is preferable to use the two-component developer, in terms of improvement of operation life.

The carrier is not particularly limited and may be suitably selected in accordance with the intended use, however, the carrier preferably includes a core material and a resin layer for coating the core material.

A material of the core material is not particularly limited and may be suitably selected from hitherto known materials. Preferred examples thereof include a manganese-strontium (Mn—Sr) based material and a manganese-magnesium (Mn—Mg) based material in a range of 50 emu/g to 90 emu/g. From the viewpoint of ensuring the image density, a highly magnetized material such as iron powder (100 emu/g or more) and magnetite (75 emu/g to 120 emu/g) is preferable. Moreover, a weakly magnetized material such as a copper-zinc (Cu—Zn) based material (30 emu/g to 80 emu/g) is preferable since the weakly magnetized material is capable of weakening a contact with a photoconductor on which the toner is erected (forming a brush) and advantageous in having a high image quality. These may be used alone or in combination.

As a particle diameter of the core material, the average particle diameter (mass average particle diameter (D₅₀)) is preferably 10 μm to 200 μm, and more preferably 40 μm to 100 μm. When the average particle diameter (mass average particle diameter (D₅₀)) is less than 10 μm, in a distribution of carrier particles, fine particles are increased and a magnetization per particle becomes low, thereby causing scattering of the carrier. When the average particle diameter (mass average particle diameter (D₅₀)) is more than 200 μm, a specific surface area is decreased, and toner scattering may occur. In a full color having a substantial solid portion, reproducibility of the solid portion in particular may degrade.

A material of the resin layer is not particularly limited, and may be suitably selected from among hitherto known resins in accordance with the intended use. Examples of the material of the resin layer include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acrylic monomers, copolymers of vinylidene fluoride and vinyl fluoride, fluoroterpolymers (fluorinated tri-(multi-)copolymers) such as terpolymers of tetrafluoroethylene with vinylidene fluoride with non-fluoride monomer, silicon resins, and the like. These may be used alone or in combination. Among these, silicone resins are particularly preferable.

The silicone resin is not particularly limited and may be suitably selected from among generally known silicone resins in accordance with the intended use. Examples of the silicone resins include straight silicone resins having only organosiloxane bonding; and silicone resins which are modified with alkyd resin, polyester resin, epoxy resin, acrylate resin, urethane resin and the like.

As the silicone resins, commercially available products can be used. Examples of commercially available straight silicone resins include KR271, KR255 and KR152 (produced by Shin-Etsu Chemical Co., Ltd.); and SR2400, SR2406 and SR2410 (produced by TORAY Dow Corning Silicone Co., Ltd.).

As the modified silicone resins, commercially available products can be used. Examples of commercially available modified silicone resins include KR206 (alkyd-modified), KR5208 (acryl-modified), ES1001N (epoxy-modified), KR305 (urethane-modified) produced by Shin-Etsu Chemical Co., Ltd.; and SR2115 (epoxy-modified) and SR2110 (alkyd-modified) produced by TORAY Dow Corning Silicone Co., Ltd.

Note that a silicone resin can also be used as a single substance, or a crosslinkable component, a charge controlling component may also be used together.

The resin layer may contain a conductive powder and the like in accordance with the necessity. Examples of the conductive powder include metal powders, carbon blacks, titanium oxides, tin oxides and zinc oxides. An average particle diameter of these conductive powders is preferably 1 μm or smaller. When the average particle diameter is larger than 1 μm, it may become difficult to control the electric resistance.

The resin layer can be formed, for example, by the following method. The silicone resin and the like are dissolved in a solvent to prepare a coating solution liquid, the solution liquid is applied uniformly to the surface of the core material by a known coating method, followed by drying and baking, thereby a resin layer can be formed. As the coating method, for example, dip-coating method, spray-coating method, brush-coating method are exemplified.

The solvent is not particularly limited and may be suitably selected in accordance with the intended use. Examples thereof include toluene, xylylene, methyl ethyl ketone, methyl isobutyl ketone, cellosolve, and butyl acetate.

The baking is not particularly limited and may be externally heating or internally heating. For example, a method of using a fixed type electric furnace, a fluid type electric furnace, a rotary type electric furnace or a burner furnace; a method of using a microwave are exemplified.

The amount of the resin layer in the carrier is preferably 0.01% by mass to 5.0% by mass. When the amount the resin layer is less than 0.01% by mass, the resin layer may not be formed, and when it is more than 5.0% by mass, carrier particles are agglomerated each other because of excessively thickened resin layer, and uniform carrier particles may not be obtained.

When the developer is a two-component developer, the amount of the carrier contained in the two-component developer is not particularly limited and may be suitably adjusted in accordance with the intended use, for example, it is preferably 90% by mass to 98% by mass, and more preferably 93% by mass to 97% by mass.

The mixing ratio of the toner and the carrier in the two-component developer is preferably 1 part by mass to 10.0 parts by mass relative to 100 parts by mass of carrier.

The toner and the developer of the present invention are capable of achieving low-temperature fixability, offset resistance and heat resistant storage stability on a level suitable for use in super high-speed image forming systems, reducing the occurrence of odor and which have remarkable effect of improving smear resistance on developing roller, fixing members and the like and are also excellent in pulverizability and productivity, and thus they are favorably used in super high-speed printing systems which can be used, for example, in print on demand (POD) technology.

A toner obtained from the method for producing a toner, according to the present invention, and a two-component developer containing the toner and a carrier composed of magnetic particles can be charged in a process cartridge for use.

In other words, the toner and the developer of the present invention can be charged in a process cartridge, which is detachably mounted to a main body of an image forming apparatus provided with integrally at least a photoconductor and one unit selected from a charging unit configured to charge a surface of the photoconductor, an exposing unit configured to expose the charge surface of the photoconductor to form a latent electrostatic image, a developing unit configured to develop the formed latent electrostatic image using a toner or developer containing the toner and a carrier to form a visible image, a transfer unit configured to transfer a developed toner image onto a recording medium, and a cleaning unit configured to remove residual toner remaining the surface of the photoconductor after the transfer, and a cleaning unit configured to remove toner remaining on the surface of the photoconductor.

As shape of the process cartridge, one shape shown in FIG. 5 is exemplified as a typical example. FIG. 5 is a schematic cross-sectional diagram showing a structural example of a process cartridge according to the present invention. In the periphery of a photoconductor 11, arranged are a charge controlling device 12 which is a charge controlling unit; an exposing device 13 which is an exposing unit; a developing device 14 which is a developing unit, a transferer 16 which is a transfer unit, a cleaning device 17 which is a cleaning unit, and a charge eliminating device 1A which is a charge eliminating device. In this case, the toner of the present invention is charged in the developing device 14. Note that reference numeral 18 denotes a recording medium (e.g. paper). And, the photoconductor 11 has a drum-shape, or the shape may have a sheet-shape or endless-shape. Reference numeral 19 denotes a fixing unit.

### Examples

Hereinafter, Examples of the present invention will be described, which however shall not be construed as limiting the scope of the present invention.

In Examples and Comparative Examples described below, “softening point of polyester resin”, “glass transition temperature (Tg) of polyester resin”, “softening point of rosin”, “acid values of polyester resin and rosin”, “hydroxyl value of polyester resin”, “contained amount of low-molecular-weight component having a molecular weight of 500 or less”, “SP value of rosin”, “degree of modification of rosin with (meth)acrylic acid”, “degree of modification of rosin with fumaric acid” and “degree of modification of rosin with maleic acid” were measured in accordance with the following methods.

### <Measurement of Softening Point of Polyester Resin>

Using Flow Tester (manufactured by Shimadzu Corporation, CFT-500D), 1 g of each polyester-based binder resin as a sample was extruded through a nozzle having a diameter of 1 mm and a length of 1 mm by applying a load of 1.96 MPa from a plunger while heating at a temperature raising rate of 6° C./min. A fall amount of the plunger in Flow Tester to the temperature was plotted, and the temperature at which a half amount of the sample was flowed out was taken as a softening point.

### <Measurement of Glass Transition Temperature (Tg) of Polyester Resin>

Using a differential scanning calorimeter (manufactured by Seiko Electronic Industry Co., Ltd., DSC210), each polyester-based binder resin as a sample was weighed in an amount of 0.01 g to 0.02 g in an aluminum pan. After heating to 200° C., the sample cooled from the same temperature to 0° C. at a temperature falling rate of 10° C./min was heated at a temperature raising rate of 10° C./min, and then the temperature at an intersection point of an extension line of a base line at a temperature lower than an endothermic maximum peak temperature and a tangent line showing a maximum slope from a rising slope of a peak to a peak top was taken as a glass transition temperature.

<Measurement of Softening Point of Rosin>

### (1) Preparation of Sample

A rosin (10 g) was melted on a hot plate at 170° C. for 2 hours. In an opening state, the rosin was naturally cooled under an environment of a temperature of 25° C. and a relative humidity of 50% for one hour and then ground by a coffee mill (National MK-61M) for 10 seconds to obtain a sample.

### (2) Measurement

Using Flow Tester (manufactured by Shimadzu Corporation, CFT-500D), 1 g of each polyester-based binder resin as a sample was extruded through a nozzle having a diameter of 1 mm and a length of 1 mm by applying a load of 1.96 MPa from a plunger while heating at a temperature raising rate of 6° C./min. A fall amount of the plunger in Flow Tester to the temperature was plotted and the temperature at which a half amount of the sample was flowed out was taken as a softening point.

### <Acid Value of Polyester Resin and Rosin>

According to the method defined in JIS K0070, an acid value was measured. In the case of only a measurement solvent, a mixed solvent of ethanol and ether defined in JIS K0070 was replaced by a mixed solvent of acetone and toluene (acetone:toluene=1:1 (volume ratio)).

### <Hydroxyl Value of Polyester Resin>

A hydroxyl value was measured according to the method defined in JIS K0070.

### <Contained Amount of Low Molecular Weight Component Having Molecular Weight of 500 or Less>

Molecular weight distribution was measured by gel permeation chromatography (GPC). First, to 30 mg of each polyester-based binder resin, 10 ml of tetrahydrofuran was added and, after mixing using a ball mill for one hour, insoluble components were removed by filtering through a fluororesin filter having a pore size of 2 μm “FP-200” (manufactured by Sumitomo Electric Industries, Ltd.) to prepare a sample solution.

Tetrahydrofuran as an eluate was allowed to flow at a flow rate of 1 ml per minute and a column in a thermostatic bath at 40° C. was stabilized, and after injecting 100 μL of the sample solution, the measurement was performed. “GMHLX+G3000HXL” (manufactured by TOSOH CORPORATION) was used as an analytic column and a calibration curve of a molecular weight was made as a standard sample using several kinds of monodisperse polystyrenes (2.63×10³, 2.06×10⁴ and 1.02×10⁵ produced by TOSOH CORPORATION, and 2.10×10³, 7.00×10³ and 5.04×10⁴ produced by GL Sciences Inc.).

Next, the contained amount (%) of a low molecular weight component having a molecular weight of 500 or less was calculated as the proportion of an area of the corresponding region in a chart area obtained by an RI (refractive index) detector.

### <Measurement of SP Value of Rosin>

Each sample (2.1 g) in a molten state was poured into a predetermined ring and cooled to room temperature, and then a SP value was measured under the following conditions according to JIS B7410.
Measuring device: Automatic ring-and-ball softening point tester (ASP-MGK2, manufactured by MEITECH Company, Ltd.)
Temperature raising rate: 5° C./min
Initial temperature of heating: 40° C.
Measurement solvent: glycerin
   <Measurement of Degree of Modification of Rosin with (Meth)Acrylic Acid>

The degree of modification of rosin with (meth)acrylic acid was calculated by the following equation (1):

Degree of modification of rosin with (meth)acrylic acid=[(X₁−Y)/(X₂−Y)]×100 Equation (1)

In Equation (1), X₁ denotes an SP value of a (meth)acrylic acid-modified rosin whose modification degree is to be calculated, X₂ denotes a saturated SP value of a (meth)acrylic acid-modified rosin obtained by reacting 1 mol of (meth)acrylic acid with 1 mol of a rosin, and Y denotes an SP value of the rosin.

The saturated SP value means an SP value obtained in the reaction of the (meth)acrylic acid with the rosin until the SP value of the resulting (meth)acrylic acid-modified rosin reaches a saturated value. If an acid value is x (mgKOH/g), it is considered that 1 g of the rosin is reacted with x mg (x×10⁻³ g) of potassium hydroxide (molecular weight: 56.1), and thus a molecular weight of 1 mol of a rosin can be calculated by the following equation: Molecular weight=(56,100/x).

<Measurement of Degree of Modification of Rosin with Fumaric Acid>

The degree of modification of rosin with fumaric acid was calculated by the following equation (2):

Degree of modification of rosin with fumaric acid=[(X₁−Y)/(X₂−Y)]×100 Equation (2)

In Equation (2), X₁ denotes an SP value of a fumaric acid- modified rosin whose modification degree is to be calculated, X₂ denotes an SP value of a fumaric acid-modified rosin obtained by reacting 1 mol of fumaric acid with 0.7 mol of a rosin, and Y denotes an SP value of the rosin.

Here, the SP value represented by X₂ is an SP value of a fumaric acid-modified rosin obtained by raising the temperature of a mixture of 1 mol of fumaric acid, 0.7 mol of rosin and 0.4 g of t-butyl catechol from 160° C. to 200° C. for 2 hours, reacting with each other at 200° C. for 2 hours and further distilling the reactant under reduced pressure of 5.3 kPa. If an acid value is x (mgKOH/g), it is considered that 1 g of the rosin is reacted with x mg (x×10⁻³ g) of potassium hydroxide (molecular weight: 56.1), and thus a molecular weight of 1 mol of a rosin can be calculated by the following equation: Molecular weight =(56,100/x).

<Measurement of Degree of Modification of Rosin with Maleic Acid>

The degree of modification of rosin with maleic acid was calculated by the following equation (3):

Degree of modification of rosin with maleic acid=[(X₁−Y)/(X₂−Y)]×100 Equation (3)

In Equation (3), X₁ denotes an SP value of a maleic acid-modified rosin whose modification degree is to be calculated, X₂ denotes a saturated SP value of a maleic acid-modified rosin obtained by reacting 1 mol of maleic acid or a derivative thereof with 1 mol of a rosin having a conjugated diene at 230° C., and Y denotes an SP value of the rosin having a conjugated diene. Note that each of the SP values was measured in accordance with the methods described below.

### —Purification of Rosin—

In a 2,000 ml volumetric distilling flask equipped with a distilling tube, a reflux condenser and a receiver, 1,000 g of a tall rosin was added, followed by distillation under reduced pressure of 1 kPa to collect a distillate at 195° C. to 250° C. as a fraction. Hereinafter, a tall rosin subjected to purification is referred to as an unpurified rosin and a rosin collected as a fraction is referred to as a purified rosin.

Each rosin (20 g) was ground in a coffee mill (National MK-61M) for 5 seconds and passed through a sieve having a sieve opening size of 1 mm, and then the rosin powder was weighed in an amount of 0.5 g in a vial for head space (20 ml). After sampling a head space gas, impurities in an unpurified rosin and in a purified rosin were analyzed by a head space GC-MS method, in accordance with the following manner. The results are shown in Table 1.

### <Measuring Conditions of Head Space GC-MS Method>

A. Head Space Sampler (Manufactured by Agilent Co., HP7694)
   Sample temperature: 200° C.
   Loop temperature: 200° C.
   Transfer line temperature: 200° C.
   Sample heat balance time: 30 minutes
   Vial pressure gas: helium (He)
   Vial pressure time: 0.3 minutes
   Loop filling time: 0.03 minutes
   Loop equilibrium time: 0.3 minutes
   Injection time: 1 minute
B. GC (Gas Chromatography) (Manufactured by Agilent Co., HP6890)
   Analytic column: DB-1 (60 m-320 μm-5 μm)

Carrier: helium (He)

Flow conditions: 1 ml/min

Injection inlet temperature: 210° C.

Column head pressure: 34.2 kPa

Injection mode: split

Split ratio: 10:1

Oven temperature conditions: 45° C. (3 min)-10° C./min-280° C. (15 min)
C. MS (Mass Spectrometry) (Manufactured by Agilent Co., HP5973)

Ionization method: EI (electron impact) method

Interface temperature: 280° C.

Ion source temperature: 230° C.

Quadrupole temperature: 150° C.

Detection mode: Scan 29 m/s to 350 m/s

TABLE 1

| | | | | | | SP value | | |
|---|---|---|---|---|---|---|---|---|
| | | | | | | (° C.) | | |
| | | | | | | Softening | | |
| | hexanoic | pentanoic | | | | point | Acid value | Molecular |
| | acid | acid | benzaldehyde | n-hexanal | 2-pentylfuran | (° C.) | (mgKOH/g) | weight/mole |
| Unpurified | 0.9 × 10⁷ | 0.6 × 10⁷ | 0.6 × 10⁷ | 1.8 × 10⁷ | 1.1 × 10⁷ | 77 | 169 | 332 |
| rosin | | | | | | 74.3 | | |
| Purified | 0.4 × 10⁷ | 0.2 × 10⁷ | 0.2 × 10⁷ | 1.4 × 10⁷ | 0.7 × 10⁷ | 76.8 | 166 | 338 |
| rosin | | | | | | 75.1 | | |

### <Measurement of SP Value of Acrylic Acid-Modified Rosin Using Unpurified Rosin>

In a 1,000 ml volumetric flask equipped with a distilling tube, a reflux condenser and a receiver, 332 g (1 mol) of an unpurified rosin (SP value: 77.0° C.) and 72 g (1 mol) of acrylic acid were added. After heating from 160° C. to 230° C. over 8 hours, it was confirmed that an SP value did not increase at 230° C. and the unreacted acrylic acid and a low boiling point substance were distilled away under reduced pressure of 5.3 kPa to obtain an acrylic acid-modified rosin. An SP value of the resulting acrylic acid-modified rosin, that is, a saturated SP value of an acrylic acid-modified rosin using an unpurified rosin was 110.1° C.

### <Measurement of Saturated SP Value of Acrylic Acid-Modified Rosin Using Purified Rosin>

In a 1,000 ml volumetric flask equipped with a distilling tube, a reflux condenser and a receiver, 338 g (1 mol) of a purified rosin (SP value: 76.8° C.) and 72 g (1 mol) of acrylic acid were added. After heating from 160° C. to 230° C. over 8 hours, it was confirmed that an SP value did not increase at 230° C. and the unreacted acrylic acid and a low boiling point substance were distilled away under reduced pressure of 5.3 kPa to obtain an acrylic acid-modified rosin. An SP value of the resulting acrylic acid-modified rosin, that is, a saturated SP value of an acrylic acid-modified rosin using a purified rosin was 110.4° C.

### —Synthesis of Acrylic Acid-Modified Rosin A—

In a 10 L volumetric flask equipped with a distilling tube, a reflux condenser and a receiver, 6,084 g (18 mol) of a purified rosin (SP value: 76.8° C.) and 907.9 g (12.6 mol) of acrylic acid were added. After heating from 160° C. to 220° C. over 8 hours, the reaction was performed at 220° C. for 2 hours and distillation was performed under reduced pressure of 5.3 kPa to obtain an acrylic acid-modified rosin A. An SP value of the resulting acrylic acid-modified rosin A was 110.4° C. and the degree of modification with acrylic acid was 100.

### —Synthesis of Acrylic Acid-Modified Rosin B—

In a 10 L volumetric flask equipped with a distilling tube, a reflux condenser and a receiver, 6,084 g (18 mol) of a purified rosin (SP value: 76.8° C.) and 648.5 g (9.0 mol) of acrylic acid were added. After heating from 160° C. to 220° C. over 8 hours, the reaction was performed at 220° C. for 2 hours and distillation was performed under reduced pressure of 5.3 kPa to obtain an acrylic acid-modified rosin B. An SP value of the resulting acrylic acid-modified rosin B was 99.1° C. and the degree of modification with acrylic acid was 66.4.

### —Synthesis of Acrylic Acid-Modified Rosin C—

In a 10 L volumetric flask equipped with a distilling tube, a reflux condenser and a receiver, 6,084 g (18 mol) of a purified rosin (SP value: 76.8° C.) and 259.4 g (3.6 mol) of acrylic acid were added. After heating from 160° C. to 220° C. over 8 hours, the reaction was performed at 220° C. for 2 hours and distillation was performed under reduced pressure of 5.3 kPa to obtain an acrylic acid-modified rosin C. An SP value of the resulting acrylic acid-modified rosin C was 91.9° C. and the degree of modification with acrylic acid was 44.9.

### —Synthesis of Acrylic Acid-Modified Rosin D—

In a 10 L volumetric flask equipped with a distilling tube, a reflux condenser and a receiver, 5,976 g (18 mol) of an unpurified rosin (SP value: 77.0° C.) and 907.6 g (12 mol) of acrylic acid were added. After heating from 160° C. to 220° C. over 8 hours, the reaction was performed at 250° C. for 2 hours and distillation was performed under reduced pressure of 5.3 kPa to obtain an acrylic acid-modified rosin D. An SP value of the resulting acrylic acid-modified rosin D was 110.1° C. and the degree of modification with acrylic acid was 100.

### —Synthesis of Polyester-Based Binder Resins A1 to A8—

An alcohol component, a carboxylic acid component other than trimellitic anhydride, and an esterifying catalyst shown in Table 2-A were charged in a 5 liter volumetric four-necked flask equipped with a distilling tube through which hot water (98° C.) had been passed and which was provided at the upper portion a reflux cooling tube through which cool water whose temperature was room temperature had been passed, a nitrogen inlet tube, a dewatering tube, a stirrer and a thermocouple and the polycondensation reaction was performed under a nitrogen atmosphere at 160° C. for 2 hours, the reactant temperature was raised to 210° C. over 6 hours, and then the reaction was performed under 66 kPa for one hour. After cooling to 200° C., trimellitic anhydride was charged and the reaction was performed under a normal pressure (101.3 kPa) for one hour, the reactant temperature was raised to 210° C., and then the reaction was performed under 40 kPa until the temperature reached a desired softening point, and thus polyester-based binder resins A1 to A8 were synthesized. The acid value, the hydroxyl value, the softening point, the glass transition temperature, and the contained amount of a low molecular weight component having a molecular weight of 500 or less of each of the resins are shown in Table 2-B.

TABLE 2-A

| | | Polyester Resin No. | | | | | | | |
|---|---|---|---|---|---|---|---|---|---|
| | | A1 | A2 | A3 | A4 | A5 | A6 | A7 | A8 |
| Alcohol | 1,2-propanediol | 889 g | 889 g | 1,254 g | 740 g | 721 g | 889 g | 889 g | 1,064 g |
| component | 1,3-propanediol | 258 g | 258 g | — | — | — | 258 g | 258 g | — |
| | 1,4-butanediol | — | — | — | 252 g | — | — | — | — |
| | BPA-PO* | — | — | — | — | 882 g | — | — | — |
| | glycerin | 166 g | 166 g | — | 135 g | — | 166 g | 166 g | — |
| Carboxylic | terephthalic acid | 2,108 g | 2,108 g | 2,054 g | 1,809 g | 1,195 g | 2,108 g | 2,108 g | 1,720 g |
| acid | trimellitic anhydride | 307 g | 307 g | 380 g | 100 g | 277 g | 307 g | 307 g | 54 g |
| component | unpurified rosin | — | — | — | — | — | — | — | 1,027 g |
| | acrylic acid-modified | 764 g | — | 252 g | 878 g | 932 g | — | — | — |
| | rosin A | | | | | | | | |
| | acrylic acid-modified | — | 764 g | — | — | — | — | — | — |
| | rosin B | | | | | | | | |
| | acrylic acid-modified | — | — | — | — | — | — | 764 g | — |
| | rosin C | | | | | | | | |
| | acrylic acid-modified | — | — | — | — | — | 776 g | — | — |
| | rosin D | | | | | | | | |
| Esterifying | butyltin oxide | — | — | 15 g | — | 20 g | — | — | — |
| catalyst | tin (II) | 20 g | 20 g | — | — | — | 20 g | 20 g | 20 g |
| | 2-ethylhexanoate | | | | | | | | |
| | titanium | — | — | — | 25 g | — | — | — | — |
| | diisopropylate | | | | | | | | |
| | bis(triethanol | | | | | | | | |
| | aminate) | | | | | | | | |

| | | | | | | | | |
|---|---|---|---|---|---|---|---|---|
| Amount of rosin contained in | 24.0 | 24.0 | 9.4 | 31.5 | 38.8 | 24.3 | 38.8 | 36.7 |
| carboxylic acid component | | | | | | | | |
| (% by mass) | | | | | | | | |

TABLE 2-B

| | | Polyester Resin No. | | | | | | | |
|---|---|---|---|---|---|---|---|---|---|
| | | A1 | A2 | A3 | A4 | A5 | A6 | A7 | A8 |
| Physical | Acid value | 26.4 | 25.2 | 56.1 | 51.2 | 27.8 | 71.8 | 16.4 | 28.4 |
| properties | (mgKOH/g) | | | | | | | | |
| of | Hydroxyl value | 18.8 | 16.9 | 39.6 | 22.5 | 20.3 | 64.3 | 10.9 | 21.2 |
| polyester | (mgKOH/g) | | | | | | | | |
| resin | Softening point (° C.) | 120.7 | 116.1 | 102.9 | 120.5 | 112.2 | 119.1 | 114.8 | 105.9 |
| | Glass transition | 68.1 | 67.3 | 59.4 | 59.4 | 62.5 | 69.5 | 64.5 | 54.9 |
| | temperature (° C.) | | | | | | | | |
| | Amount of | 5.3 | 7.2 | 7.6 | 7.1 | 8.2 | 6.1 | 9.6 | 14.2 |
| | low-molecular | | | | | | | | |
| | weight component | | | | | | | | |
| | having molecular | | | | | | | | |
| | weight of 500 or less | | | | | | | | |
| | (%) | | | | | | | | |

* Unpurified rosin: unpurified rosin
*BPA-PO: propylene oxide adduct of bisphenol A; polyoxypropylene(2.2)-2,2-bis(4-hydroxyphenyl)propane

### —Synthesis of Polyester Resins B1 to B7—

An alcohol component, a carboxylic acid component other than trimellitic anhydride, and an esterifying catalyst shown in Table 3 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then reaction was performed at 230° C. under 8 kPa for one hour. After cooling to 220° C., trimellitic anhydride shown in Table 3 was charged, followed by reaction under a normal pressure (101.3 kPa) for one hour, and then the reaction was performed at 220° C. under 20 kPa until the temperature reached a desired softening point, and thus polyester resins B1 to B7 were synthesized. The softening point, the glass transition temperature, and the acid value of each of the resins are shown in Table 3.

TABLE 3

| | | Polyester Resin No. | | | | | | |
|---|---|---|---|---|---|---|---|---|
| | | B1 | B2 | B3 | B4 | B5 | B6 | B7 |
| Alcohol | BPA-PO* | 517 g | 517 g | — | — | 258 g | 517 g | 517 g |
| component | BPF-PO* | — | — | 380 g | 380 g | — | — | — |
| | 1,2-propanediol | — | — | 23 g | 23 g | 57 g | — | — |
| Carboxylic | terephthalic acid | 125 g | 125 g | 125 g | 125 g | 150 g | 125 g | 150 g |
| acid | itaconic acid | 78 g | 78 g | 78 g | 78 g | 39 g | 78 g | 39 g |
| component | trimellitic | 144 g | 144 g | 144 g | 144 g | 173 g | 144 g | 173 g |
| | anhydride | | | | | | | |
| Esterifying | tin (II) | 6 g | 4 g | 4 g | 3 g | 4 g | 8 g | 4 g |
| catalyst | 2-ethylhexanoate | | | | | | | |
| Amount of bisphenol compound | | 100 | 100 | 80 | 80 | 50 | 100 | 100 |
| contained in alcohol component | | | | | | | | |
| Physical | Softening point | 119.4 | 112.0 | 80.3 | 76.5 | 111.7 | 122.3 | 118.5 |
| properties | (° C.) | | | | | | | |
| of polyester | Glass transition | 61.2 | 60.6 | 57.2 | 55.3 | 60.3 | 62.3 | 62.1 |
| resin | temperature (° C.) | | | | | | | |
| | Acid value | 10.2 | 10.4 | 5.6 | 6.7 | 13.3 | 13.5 | 27.8 |
| | (mgKOH/g) | | | | | | | |

*BPA-PO: propylene oxide adduct of bisphenol A; polyoxypropylene (2.2)-2,2-bis(4-hydroxyphenyl)propane
*BPF-PO: propylene oxide adduct of bisphenol F; polyoxypropylene (2.2)-2,2-bis(4-hydroxyphenyl)methane

### Examples A1 to A22 and Comparative Examples A1 to A2

### —Production of Toner—

Components of the combination of a binder resin, a releasing agent and a colorant (type and formulation amount) shown in Table 4 were premixed using a HENSCHEL MIXER (manufactured by Mitsui Miike Kakouki Co., Ltd., FM10B) and melted and kneaded by a biaxial kneader (manufactured by IKEGAI, LTD., PCM-30) at a temperature of 100° C. to 130° C. The resulting kneaded product was cooled to the room temperature and then coarsely crushed to particle sizes of 200 μm to 300 μm by a hammer mill. Next, the crushed particles were finely pulverized by a supersonic jet pulverizer (LABOJET manufactured by Nihon Pneumatic Industry Co., Ltd.) while appropriately adjusting a pulverizing air pressure so as to have mass average particle diameters of 8.2 μm±0.3 μm, and then classified by an air classifier (manufactured by Nihon Pneumatic Industry Co., Ltd., MDS-I) while appropriately adjusting its louver opening so that the mass average particle diameters were 9.0 μm±0.2 μm and the amount of fine powder particles having particle diameters of 4 μm or less was 10% by number or less, and thus toner base particles were obtained. Next, an additive (HDK-2000, produced by Clariant Japan K.K.) in an amount of 1.0 part by mass to 100 parts by mass of the toner base particles was stirred and mixed with each other in a HENSCHEL MIXER, thereby producing Toners A1 to A24, respectively.

TABLE 4

| | | Binder Resin | | | | | | | |
|---|---|---|---|---|---|---|---|---|---|
| | Toner | Polyester resin (A) | | Polyester resin (B) | | Releasing agent | | Colorant | |
| Ex. A1 | Toner A1 | Resin A1 | 50 parts | Resin B1 | 50 parts | carnauba wax | 5 parts | carbon black | 8 parts |
| Ex. A2 | Toner A2 | Resin A1 | 50 parts | Resin B2 | 50 parts | carnauba wax | 5 parts | carbon black | 8 parts |
| Ex. A3 | Toner A3 | Resin A1 | 50 parts | Resin B3 | 50 parts | carnauba wax | 5 parts | carbon black | 8 parts |
| Ex. A4 | Toner A4 | Resin A2 | 50 parts | Resin B1 | 50 parts | carnauba wax | 5 parts | carbon black | 8 parts |
| Ex. A5 | Toner A5 | Resin A2 | 50 parts | Resin B2 | 50 parts | carnauba wax | 5 parts | carbon black | 8 parts |
| Ex. A6 | Toner A6 | Resin A2 | 50 parts | Resin B3 | 50 parts | carnauba wax | 5 parts | carbon black | 8 parts |
| Ex. A7 | Toner A7 | Resin A3 | 50 parts | Resin B1 | 50 parts | carnauba wax | 5 parts | carbon black | 8 parts |
| Ex. A8 | Toner A8 | Resin A3 | 50 parts | Resin B2 | 50 parts | carnauba wax | 5 parts | carbon black | 8 parts |
| Ex. A9 | Toner A9 | Resin A3 | 50 parts | Resin B3 | 50 parts | carnauba wax | 5 parts | carbon black | 8 parts |
| Ex. A10 | Toner A10 | Resin A4 | 50 parts | Resin B1 | 50 parts | carnauba wax | 5 parts | carbon black | 8 parts |
| Ex. A11 | Toner A11 | Resin A4 | 50 parts | Resin B2 | 50 parts | carnauba wax | 5 parts | carbon black | 8 parts |
| Ex. A12 | Toner A12 | Resin A4 | 50 parts | Resin B3 | 50 parts | carnauba wax | 5 parts | carbon black | 8 parts |
| Ex. A13 | Toner A13 | Resin A3 | 90 parts | Resin B3 | 10 parts | carnauba wax | 5 parts | carbon black | 8 parts |
| Ex. A14 | Toner A14 | Resin A1 | 40 parts | Resin B3 | 60 parts | carnauba wax | 5 parts | carbon black | 8 parts |
| Ex. A15 | Toner A15 | Resin A1 | 30 parts | Resin B3 | 70 parts | carnauba wax | 5 parts | carbon black | 8 parts |
| Ex. A16 | Toner A16 | Resin A1 | 50 parts | Resin B4 | 50 parts | carnauba wax | 5 parts | carbon black | 8 parts |
| Ex. A17 | Toner A17 | Resin A1 | 50 parts | Resin B5 | 50 parts | carnauba wax | 5 parts | carbon black | 8 parts |
| Ex. A18 | Toner A18 | Resin A1 | 50 parts | Resin B6 | 50 parts | carnauba wax | 5 parts | carbon black | 8 parts |
| Ex. A19 | Toner A19 | Resin A1 | 50 parts | Resin B7 | 50 parts | carnauba wax | 5 parts | carbon black | 8 parts |
| Ex. A20 | Toner A20 | Resin A5 | 50 parts | Resin B3 | 50 parts | carnauba wax | 5 parts | carbon black | 8 parts |
| Ex. A21 | Toner A21 | Resin A6 | 50 parts | Resin B3 | 50 parts | carnauba wax | 5 parts | carbon black | 8 parts |
| Ex. A22 | Toner A22 | Resin A7 | 50 parts | Resin B3 | 50 parts | carnauba wax | 5 parts | carbon black | 8 parts |
| Comp. Ex. A1 | Toner A23 | Resin A1 | 100 parts | — | — | carnauba wax | 5 parts | carbon black | 8 parts |
| Comp. Ex. A2 | Toner A24 | Resin A8 | 50 parts | Resin B3 | 50 parts | carnauba wax | 5 parts | carbon black | 8 parts |

* In Table 4, “parts” means “parts by mass”.

### —Preparation of Carrier—

According to the following coating material formulation, components were dispersed by a stirrer for 10 minutes to prepare a coating liquid. This coating liquid and 5,000 parts by mass of a core material (Cu—Zn ferrite particle, mass average particle diameter=80 μm) were charged in a coating device for coating while forming a spinning stream, equipped with a fluidized bed, a rotary bottom plate disc and a stirring blade disc arranged in the fluidized bed, and the coating material was coated with the coating liquid. The resulting coated core material was baked in an electric furnace at 280° C. for 2 hours to prepare a carrier.

### [Composition of Coating Material]

| | |
|---|---|
| toluene | 450 parts by mass |
| silicone resin (SR2400, produced by TORAY Dow | 450 parts by mass |
| Corning Silicone Co., Ltd., nonvolatile content: | |
| 50% by mass) | |
| aminosilane (SH6020, produced by TORAY Dow | 10 parts by mass |
| Corning Silicone) | |
| carbon black | 10 parts by mass |

### —Preparation of Two-Component Developer—

Each of 5% by mass of Toners A1 to A24 thus obtained and 95% by mass of the carrier thus obtained were uniformly mixed and triboelectrically charged using a tubular mixer (manufactured by Willy A. Bachofen (WAB) AG Maschinenfabrik, T2F) at 48 rpm for 5 minutes to prepare two-component developers A1 to A24.

### —Evaluation of Physical Properties—

Next, Toners of Examples and Comparative Examples A1 to A24 were evaluated for pulverizability, cold offset resistance, hot offset resistance, smear resistance on developing roller, heat resistant storage stability and odor property. The evaluation results are shown in Table 5.

Note that smear resistance on developing roller, cold offset resistance, and hot offset resistance were evaluated after each of the developers of Examples and Comparative Examples A1 to A24 had been charged in an image forming apparatus.

Here, as the image forming apparatus, a remodeled machine of a super high-speed digital laser printer, IPSIO SP9500PRO (manufactured by Ricoh Company Ltd., printing speed: 156 sheets/min (A4 size paper sheet, fed into the printing section from its longer side) employing a two-component developing method and a direct transfer method and a heat roller fixing method was used.

### <Pulverizability>

A molten kneaded product of the toner raw material obtained in the production of the toners of Examples and Comparative Examples was coarsely crushed by a hammer mill to 200 μm to 300 μm, and 10.00 g (precisely weighed) of the crushed powder was pulverized in a mill & mixer Model MM-I (manufactured by Hitachi Living Systems) for 30 seconds, and then sieved through a sieve of 30 mesh (sieve opening size: 500 μm). A mass (A) g of the resin that had not been passed through the sieve was precisely weighed, and the residual rate of the toner raw material was determined from the following Equation (i). This operation was repeated three times, and an average value of the residual rates was used an indicator of pulverizability. Then, evaluation for pulverizability was carried out according to the following evaluation criteria. The smaller the average value of residual rate is, the more excellent pulverizability is.

Residual Rate (%)=[(A)/mass of toner before being pulverized (10.00 g)]×100 [Equation (i)]

### [Evaluation Criteria]

A: The residual rate was less than 3%.

B: The residual rate was 3% or more and less than 8%.

C: The residual rate was 8% or more and less than 15% (which is as same as the residual rates obtained from conventional toners).

D: The residual rate was 15% or more and less than 20%.

E: The residual rate was 20% or more.

### <Heat Resistant Storage Stability>

The heat resistant storage stability was measured using a needle penetration tester (manufactured by Nihon Kagaku Engineering K.K.). More specifically, each of the toners was weighed in an amount of 10 g and put in a 30 ml glass vial (screw vial) under an environment of a temperature of 20° C. to 25° C. and a relative humidity of 40% to 60% and the vial was sealed with a lid. The glass vial containing the toner was tapped 200 times and then left standing in a thermostatic bath maintained at a temperature of 50° C. for 48 hours. Then, a degree of penetration was measured by the needle penetration tester, and the evaluation for heat resistant storage stability was carried out according to the following criteria. The greater the value of degree of penetration is, the more excellent heat resistant storage stability is.

### [Evaluation Criteria]

A: The degree of penetration was 30 mm or more.

B: The degree of penetration was 20 mm to 29 mm.

C: The degree of penetration was 15 mm to 19 mm (which is as same as the rates of penetration obtained from conventional toners).

D: The degree of penetration was 8 mm to 14 mm.

E: The degree of penetration was 7 mm or less.

### <Cold Offset Resistance>

Each of the developers was charged in a super high-speed digital laser printer, IPSIO SP9500PRO, and a solid image having a size of 1 cm square was formed on a transfer sheet of heavy paper (produced by NBS Ricoh Co., Ltd., copy print paper <135>) with a toner adhesion amount of 0.20 mg/cm²±0.1 mg/cm². A “Scotch Mending Tape 810” (tape width=24 mm, produced by Sumitomo 3M Ltd.) was attached on the solid image, and a metal roller (made of SUS; diameter=50 mm) having a weight of 1 kg was rolled back and forth 10 times over the tape at a rolling speed of 10 mm/s. The tape was peeled off in a given direction at a speed of 10 mm/s, and an image residual rate was determined from the results of image density before and after the peeling off of the tape, using the following Equation (ii), and the evaluation for cold offset resistance was carried out according to the following evaluation criteria.

Image Residual Rate (%)=(Image density after peeling of tape/Image density before peeling of tape)×100 Equation (ii)

### [Evaluation Criteria]

A: The image residual rate was 97% or more.

B: The image residual rate was 92% or more and less than 97%.

C: The image residual rate was 85% or more and less than 92%.

D: The image residual rate was 80% or more and less than 85% (which is as same as the image rates obtained from conventional toners).

E: The image residual rate was less than 80%.

### <Hot Offset Resistance>

Each of the developers was charged in a super high-speed digital laser printer, IPSIO SP9500PRO, and a solid image having a size of 1 cm square was formed on a transfer sheet of thin paper (produced by NBS Ricoh Co., Ltd., copy print paper <55>) with a toner adhesion amount of 0.40 mg/cm²±0.1 mg/cm². The image was fixed while varying the fixing roller temperature, and presence or absence of hot offset was visually observed. An upper limit temperature at which no hot offset occurred was determined as an upper limit fixing temperature, and the evaluation for hot offset resistance was carried out according to the following evaluation criteria.

### [Evaluation Criteria]

A: The upper limit fixing temperature was 240° C. or more.

B: The upper limit fixing temperature was 220° C. or more and less than 240° C.

C: The upper limit fixing temperature was 200° C. or more and less than 220° C.

D: The upper limit fixing temperature was 180° C. or more and less than 200° C. (which is as same as the upper limit temperatures of conventional toners).

E: The upper limit fixing temperature was less than 180° C.

### <Smear Resistance on Developing Roller>

Each of the developers was charged in a super high-speed digital laser printer, IPSIO SP9500PRO, and a running printing test of 100,000 sheets was performed using an image chart having an image area ratio of 5%. After the running printing test, the developer and toner on the developing roller were removed therefrom, and the evaluation for smear resistance on developing roller was carried out by visually observing smear on the surface of the developing roller in the paper passing part.

### [Evaluation Criteria]

A: No smear observed on the developing roller.

B: A slight amount of smear occurred, but it was difficult to visually distinguish.

C: A small amount of smear occurred.

D: Considerable smear occurred (which is on the substantially same level as those of conventional toners).

E: Considerable smear ocurred and it was difficult to put into practical use.

### <Evaluation Method for Odor of Toner>

Each of the toners was weighed in an amount of 20 g in an aluminum cup, the cup was left standing for 30 minutes on a hot plate which was heated at 150° C., and odor generated from the toner was evaluated according to the following evaluation criteria.

### [Evaluation Criteria]

A: No odor was detected.

B: Almost no odor was detected.

C: Odor was slightly detected, but no problem in practical use.

D: Strong odor was detected.

TABLE 5

| | | | Heat resistant | | | Smear | |
|---|---|---|---|---|---|---|---|
| | | | storage | Cold offset | Hot offset | resistance on | |
| | Toner | Pulverizability | stability | resistance | resistance | developing roller | Odor |
| Ex. A1 | Toner A1 | B | A | B | A | A | A |
| Ex. A2 | Toner A2 | B | B | B | B | B | A |
| Ex. A3 | Toner A3 | B | B | A | B | B | A |
| Ex. A4 | Toner A4 | B | A | B | B | A | B |
| Ex. A5 | Toner A5 | B | B | B | B | B | B |
| Ex. A6 | Toner A6 | B | B | A | B | B | B |
| Ex. A7 | Toner A7 | B | B | A | B | B | A |
| Ex. A8 | Toner A8 | B | B | A | B | B | A |
| Ex. A9 | Toner A9 | A | B | A | B | B | A |
| Ex. A10 | Toner A10 | B | A | B | A | A | A |
| Ex. A11 | Toner A11 | B | A | B | A | B | A |
| Ex. A12 | Toner A12 | B | B | B | B | B | A |
| Ex. A13 | Toner A13 | A | B | B | B | B | A |
| Ex. A14 | Toner A14 | B | B | A | B | B | A |
| Ex. A15 | Toner A15 | B | B | C | B | B | A |
| Ex. A16 | Toner A16 | A | C | B | C | C | A |
| Ex. A17 | Toner A17 | A | C | B | C | C | A |
| Ex. A18 | Toner A18 | C | A | C | A | A | A |
| Ex. A19 | Toner A19 | B | B | C | C | B | A |
| Ex. A20 | Toner A20 | C | B | C | B | A | A |
| Ex. A21 | Toner A21 | B | B | C | C | B | C |
| Ex. A22 | Toner A22 | B | C | B | B | B | A |
| Comp. Ex. A1 | Toner A23 | B | C | B | C | D | A |
| Comp. Ex. A2 | Toner A24 | A | E | A | C | C | D |

The results shown in Table 5 demonstrated that as compared to Comparative Examples A1 and A2, Examples A1 to A22 are more capable of achieving low-temperature fixability, offset resistance and heat resistant storage stability on the level suitable for use in super high-speed image forming systems, reducing the generation of odor, have noteworthy smear resistance on developing roller etc., and are excellent in productivity.

### Examples of Toners According to Second Embodiment

### —Purification of Rosin—

In a 2,000 ml volumetric distilling flask equipped with a distilling tube, a reflux condenser and a receiver, 1,000 g of a tall rosin was added, followed by distillation under reduced pressure of 13.3 kPa to collect a distillate at 195° C. to 250° C. as a fraction. Hereinafter, a tall rosin subjected to purification is referred to as an unpurified rosin A and a rosin collected as a fraction is referred to as a purified rosin B.

Each rosin (20 g) was ground in a coffee mill (National MK-61M) for 5 seconds and passed through a sieve having a sieve opening size of 1 mm, and then the rosin powder was weighed in an amount of 0.5 g in a vial for head space (20 ml). After sampling a head space gas, impurities in an unpurified rosin A and in a purified rosin B were analyzed by a head space GC-MS method, according to the manner described above. The results are shown in Table 6.

TABLE 6

| | hexanoic | pentanoic | | | | Softening | Acid value |
|---|---|---|---|---|---|---|---|
| | acid | acid | benzaldehyde | n-hexanal | 2-pentylfuran | point (° C.) | (mgKOH/g) |
| Rosin A | 0.9 × 10⁷ | 0.6 × 10⁷ | 0.6 × 10⁷ | 1.8 × 10⁷ | 1.1 × 10⁷ | 74.3 | 169 |
| (unpurified | | | | | | | |
| rosin) | | | | | | | |
| Rosin B | 0.6 × 10⁷ | 0.4 × 10⁷ | 0.4 × 10⁷ | 1.6 × 10⁷ | 0.9 × 10⁷ | 75.0 | 167 |
| (purified | | | | | | | |
| rosin) | | | | | | | |

### —Synthesis of Polyester-Based Binder Resins C1 to C3 and C6 to C11—

An alcohol component, a carboxylic acid component other than trimellitic anhydride, and an esterifying catalyst shown in Tables 7 and 8 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then the reaction was performed at 230° C. under 8.0 kPa for one hour. After cooling to 220° C., trimellitic anhydride was charged and the reaction was performed under a normal pressure for one hour, and then the reaction was performed at 220° C. under 20 kPa until the temperature reached a desired softening point, and thus polyester-based binder resins C1 to C3 and C6 to C11 were synthesized.

### —Synthesis of Polyester-Based Binder Resin C4—

An alcohol component, a terephthalic acid, and an esterifying catalyst shown in Table 7 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 15 hours, and then the reaction was performed at 230° C. under 8.0 kPa for one hour. After cooling to 180° C., the purified rosin B was charged and the reaction was performed at 200° C. for 15 hours. Subsequently, after cooling to 180° C., trimellitic anhydride was charged, the reactant temperature was raised to 210° C. over 2 hours, and then the reaction was performed at 210° C. under 10 kPa until the temperature reached a desired softening point, thereby synthesizing a polyester-based binder resin C4.

### —Synthesis of Polyester-Based Binder Resin C5—

An alcohol component, a terephthalic acid, and an esterifying catalyst shown in Table 7 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 15 hours, and then the reaction was performed at 230° C. under 8.0 kPa for one hour. After cooling to 180° C., the purified rosin B was charged and the reaction was performed at 200° C. for 15 hours. Subsequently, after cooling to 180° C., itaconic acid was charged, the reactant temperature was raised to 200° C. for 8 hours, after cooling to 180° C., trimellitic anhydride was charged, the reactant temperature was raised to 210° C. over 2 hours and then the reaction was performed at 210° C. under 10 kPa until the temperature reached a desired softening point, thereby synthesizing a polyester-based binder resin C5.

TABLE 7

| | | Polyester Resin Formulation No. | | | | | | | |
|---|---|---|---|---|---|---|---|---|---|
| | | C1 | C2 | C3 | C4 | C5 | C6 | C7 | C8 |
| Alcohol | BPA-PO* | 2,835 g | 2,800 g | 2,450 g | — | — | 2,800 g | 2,450 g | 2,800 g |
| component | BPF-PO* | 293 g | 650 g | 975 g | — | — | 650 g | 975 g | 650 g |
| | 1,2-propanediol | — | — | — | 1,142 g | 913 g | — | — | |
| | 1,3-propanediol | — | — | — | — | 228 g | — | — | |
| | glycerin | — | — | — | — | 276 g | — | — | |
| Carboxylic | terephthalic acid | 896 g | 1,162 g | 913 g | 1,743 g | 2,117 g | 1,162 g | 913 g | 1,162 g |
| acid | itaconic acid | — | — | — | — | 195 g | — | — | |
| component | trimellitic | 346 g | 192 g | 384 g | 288 g | 144 g | 96 g | 256 g | 192 g |
| | anhydride | | | | | | | | |
| | Unpurified Rosin A | — | — | — | — | — | — | — | 672 g |
| | Purified Rosin B | 453 g | 672 g | 504 g | 1,743 g | 498 g | 672 g | 504 g | |
| Esterifying | tin (II) | 0.5 g | 0.5 g | 0.5 g | 0.5 g | 0.5 g | 0.5 g | 0.5 g | 0.5 g |
| catalyst | 2-ethylhexanoate | | | | | | | | |
| Physical | Softening point (° C.) | 128.4 | 103.2 | 148.1 | 105 | 144.5 | 98.2 | 140.1 | 100.5 |
| properties | Glass transition | 59.3 | 63.5 | 61.3 | 58.5 | 62.5 | 57.5 | 59.3 | 60.2 |
| of polyester | temperature (° C.) | | | | | | | | |
| resin | Acid value | 31.1 | 24.5 | 25.3 | 30.9 | 35.0 | 16.5 | 19.3 | 31.4 |
| | (mgKOH/g) | | | | | | | | |

*BPA-PO: polyoxypropylene(2.2)-2,2-bis(4-hydroxyphenyl) propane
*BPA-EO: polyoxyethylene(2.2)-2,2-bis(4-hydroxyphenyl) propane

TABLE 8

| | | Polyester Resin Formulation No. | | | | | |
|---|---|---|---|---|---|---|---|
| | | C9 | | C10 | | C11 | |
| Alcohol | BPA-PO* | 2,835 | g | — | | 2,800 | g |
| component | BPA-EO* | 293 | g | — | | 650 | g |
| | BPF-PO* | — | | 2,950 | g | — | |
| | glycerin | — | | — | | — | |
| Carboxylic | terephthalic acid | 1,001 | g | 1,162 | g | 1,411 | g |
| acid | trimellitic | 346 | g | 384 | g | 192 | g |
| component | anhydride | | | | | | |
| Esterifying | tin (II) dioctanoate | 0.5 | g | 0.5 | g | 0.5 | g |
| catalyst | | | | | | | |
| Physical | Softening point (° C.) | 126.5 | | 98.2 | | 101.4 | |
| properties | Glass transition | 66.8 | | 60.3 | | 66.7 | |
| of polyester | temperature (° C.) | | | | | | |
| resin | Acid value | 23.4 | | 22.1 | | 19.4 | |
| | (mgKOH/g) | | | | | | |

*BPA-PO: polyoxypropylene(2.2)-2,2-bis(4-hydroxyphenyl)propane
*BPA-EO: polyoxyethylene(2.2)-2,2-bis(4-hydroxyphenyl)propane
*BPF-EO: polyoxypropylene(2.2)-2,2-bis(4-hydroxyphenyl)methane

### Examples B1 to B7 and Comparative Examples B1 to B3

### —Production of Toners B1 to B10—

A HENSCHEL MIXER “MODEL MF20C/I” (manufactured by Mitsui Miike Kakouki Co., Ltd.) was charged with 100 parts by mass of a binder resin shown in Table 9, 4 parts by mass of a carbon black “MOGUL L” (produced by Cabot Corporation), 1 part by mass of a negative charge controlling agent “BONTRON S-34” (produced by Orient Chemical Industries Ltd.), and 1 part by mass of propylene wax “NP-105” (produced by Mitsui Chemicals, Inc.), the components were sufficiently stirred and mixed, and the mixture was kneaded by a biaxial extruder (manufactured by TOSHIBA MACHINE CO., LTD.), followed by cooling on a steel belt. Here, the kneading was performed so that the temperature of the kneaded product at the discharge opening of the biaxial extruder was around 120° C. Subsequently, the kneaded product was ground by a jet mill so that the weight average particle size was 8.0 μm±0.5 μm. Then, the resulting powder was subjected to wind-power classification to produce toner base particles.

To 100 parts by mass of the resulting toner base particles, 1.0 part by mass of “AEROSIL R-972” (produced by Japan AEROSIL Inc.) was added as an external additive, and the components were mixed by a HENSCHEL MIXER, thereby producing toners of Examples B1 to B7 and Comparative Examples B1 to B3.

TABLE 9

| | | Binder Resin for Toner | | | | | |
|---|---|---|---|---|---|---|---|
| | | Resin | Additive | Resin | Additive | | Additive |
| | Toner | (A)-1 | amount | (A)-2 | amount | Resin (B) | amount |
| Ex. B1 | Toner B1 | Resin C1 | 50 parts | — | — | Resin C9 | 50 parts |
| Ex. B2 | Toner B2 | Resin C1 | 80 parts | — | — | Resin C9 | 20 parts |
| Ex. B3 | Toner B3 | Resin C1 | 40 parts | — | — | Resin C9 | 60 parts |
| Ex. B4 | Toner B4 | Resin C1 | 50 parts | — | — | Resin C10 | 50 parts |
| Ex. B5 | Toner B5 | Resin C2 | 25 parts | Resin C3 | 25 parts | Resin C9 | 50 parts |
| Ex. B6 | Toner B6 | Resin C4 | 25 parts | Resin C5 | 25 parts | Resin C9 | 50 parts |
| Ex. B7 | Toner B7 | Resin C6 | 25 parts | Resin C7 | 25 parts | Resin C11 | 50 parts |
| Comp. Ex. B1 | Toner B8 | Resin C1 | 85 parts | — | — | Resin C9 | 15 parts |
| Comp. Ex. B2 | Toner B9 | Resin C2 | 35 parts | — | — | Resin C9 | 65 parts |
| Comp. Ex. B3 | Toner B10 | Resin C8 | 50 parts | — | — | Resin C9 | 50 parts |

* In Table 9, “parts” means “parts by mass”.

### —Production of Carrier—

According to the following formulation, components were dispersed for 10 minutes by a homomixer to prepare a coating layer-forming solution in which an acrylic resin containing alumina particles and a silicone resin were blended.

### [Composition of Coating Layer-Forming Solution]

| | | |
|---|---|---|
| acrylic resin solution (solids content: 50% by | 21.0 | parts by mass |
| mass) | | |
| guanamine solution (solids content: 70% by mass) | 6.4 | parts by mass |
| alumina particles as microparticles [0.3 μm, | 7.6 | parts by mass |
| specific resistivity: 10¹⁴(Ω·cm)] | | |
| silicone resin solution [solids content: 23% by | 65.0 | parts by mass |
| mass, SR2410, produced by TORAY Dow | | |
| Corning Silicone Co., Ltd.] | | |
| aminosilane [solids content: 100% by mass, | 0.3 | parts by mass |
| SH6020, produced by TORAY Dow Corning | | |
| Silicone Co., Ltd.] | | |
| toluene | 60 | parts by mass |
| butylcellosolve | 60 | parts by mass |

Next, baked ferrite powder [(MgO)_{1.8}(MnO)_{49.5}(Fe₂O₃)_{48.0}, average particle diameter=35 μm] was used as a core material, the surface of the core material was coated with the coating layer-forming solution by a SPIRACOATER (manufactured by Okada Seiko Co. Ltd.), so that the thickness of the solution was 0.15 μm, followed by drying. The resulting carrier was left standing in an electric furnace at 150° C. for one hour to be baked. After cooling, the resulting ferrite powder bulk was shredded using a sieve having a sieve opening size of 106 μm, thereby obtaining a carrier.

### —Preparation of Developer—

Next, 5 parts by mass of each toner and 95 parts by mass of the carrier were stirred by a tubular mixer (T2F, manufactured by Willy A. Bachofen AG Maschinenfabrik) for 5 minutes, and thus two-component developers of Examples B1 to B7 and Comparative Examples B1 to B3 were prepared.

Next, the two component developers thus obtained were used to evaluate for low-temperature fixability, heat resistant storage stability, odor of toner, and smear resistance on fixing device, according to the following manners. The evaluation results are shown in Table 10.

### <Low-Temperature Fixability>

A super high-speed electrophotographic printing machine (INFOPRINT 4100, manufactured by Ricoh Company Limited) which had been remodeled to be suited for negative charge toner was further remodeled so that the preset temperature of the fixing device was changeable. In this printing machine, each of the developers and paper sheets (20 lbs, produced by Domtar Corp.) were set, and a printing test was performed using a solid image having an image size of 1 inch×1 inch, at a leaner speed of 1,676 mm/s. A tape “UNICEF cellophane” (MITSUBISHI PENCIL CO., LTD., width: 18 mm, JIS Z-1522) was attached to the images obtained at each fixing temperature, the image-printed sheet was passed through fixing rollers of the fixing device whose temperature was set at 30° C. Subsequently, the tape was peeled off, and optical reflection densities before and after the peeling off of the tape were measured using a reflection densitometer “RD-915” (manufactured by Macbeth Co., Ltd.). A temperature of the fixing rollers at which a ratio of the optical reflection density after the peeling-off to the optical reflection density before the peeling-off (optical reflection density after the peeling off of the tape/optical reflection density before the peeling off of the tape) exceeded 95% for the first time was defined as the lowest fixing temperature, and the evaluation for low-temperature fixability was carried out according to the following evaluation criteria.

### [Evaluation Criteria]

A: The lowest fixing temperature was lower than 180° C.

B: The lowest fixing temperature was 180° C. or higher and lower than 195° C.

C: The lowest fixing temperature was 195° C. or higher and lower than 210° C.

D: The lowest fixing temperature was 210° C. or higher.

### <Heat Resistant Storage Stability>

The heat resistant storage stability was measured using a needle penetration tester (manufactured by Nihon Kagaku Engineering K.K.). More specifically, each of the toners was weighed in an amount of 10 g and put in a 30 ml glass vial (screw vial) under an environment of a temperature of 20° C. to 25° C. and a relative humidity of 40% to 60% and the vial was sealed with a lid. The glass vial containing the toner was tapped 100 times and then left standing in a thermostatic bath maintained at a temperature of 50° C. for 48 hours. Then, a degree of penetration was measured by the needle penetration tester, and the evaluation for heat resistant storage stability was carried out according to the following criteria. The greater the value of degree of penetration is, the more excellent heat resistant storage stability is.

### [Evaluation Criteria]

A: The degree of penetration was 30 mm or more.

B: The degree of penetration was 20 mm to 29 mm (which is as same as the rates of penetration obtained from conventional toners).

C: The degree of penetration was 15 mm to 19 mm.

D: The degree of penetration was 8 mm or less.

### <Evaluation Method for Odor of Toner>

Each of the toners was weighed in an amount of 20 g in an aluminum cup, the cup was left standing for 10 minutes on a hot plate which was heated at 150° C., and odor generated from the toner was evaluated according to the following evaluation criteria.

### [Evaluation Criteria]

A: Almost no odor was detected.

B: Strong odor was detected.

### <Smear Resistance on Fixing Device>

In a super high-speed electrophotographic printing machine (INFOPRINT 4100, manufactured by Ricoh Company Limited) which had been remodeled to be suited for negative charge toner, each of the developers and paper sheets (20 lbs, produced by Domtar Corp.) were set, and a printing test was performed at a leaner speed of 1,676 mm/s. After printing 10,000 sheets of A4 size paper, a degree of contamination of a felt cleaning member was measured using a spectrophotometer (X-RITE Model 935). A small amount of toner offset on a surface of a fixing member was removed by a cleaning member, and thus the higher the ID of the cleaning member is, the larger the small offset amount is generated, which means that the degree of contamination is high. Note that the “ID” is defined by the following equation.

ID=(ID of contaminated cleaning member)−(ID of cleaning member before being contaminated)

### [Evaluation Criteria]

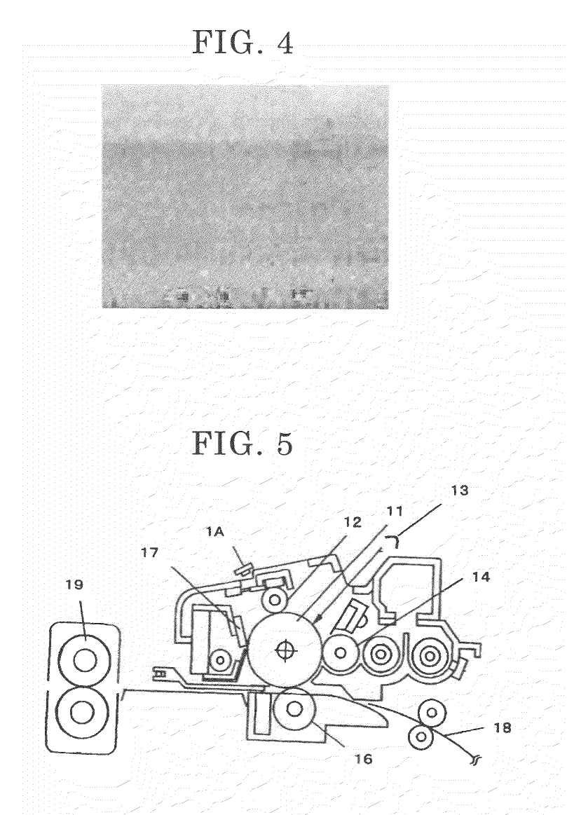

A: ID=0 to 0.2 (refer to FIG. 4)

B: ID=0.2 to 0.6 (refer to FIG. 3)

C: ID=0.6 to 1.0 (refer to FIG. 2)

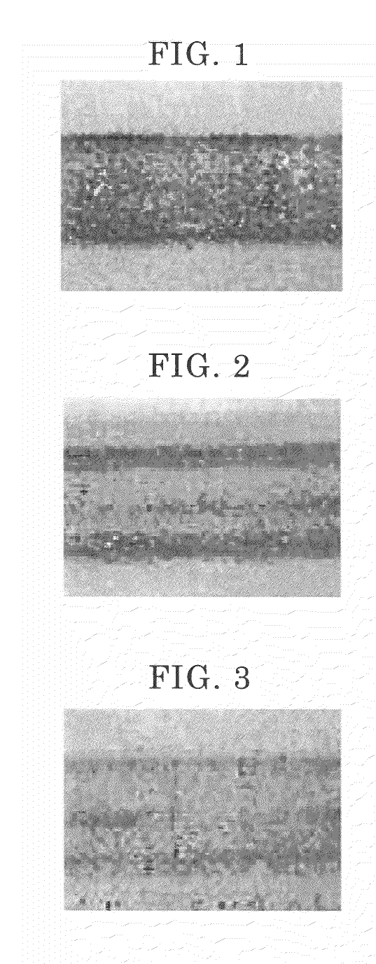

D: ID>1.0 (refer to FIG. 1)

TABLE 10

| | | Evaluation Results | | | |
|---|---|---|---|---|---|
| | | | Heat | | Smear |
| | | | resistant | | resistance |
| | | Low-temperature | storage | Odor of | on fixing |
| | Toner | fixability | stability | toner | device |
| Ex. B1 | Toner | B | B | A | A |
| | B1 | | | | |
| Ex. B2 | Toner | A | B | A | C |
| | B2 | | | | |
| Ex. B3 | Toner | C | B | A | B |
| | B3 | | | | |
| Ex. B4 | Toner | B | C | A | A |
| | B4 | | | | |
| Ex. B5 | Toner | B | A | A | B |
| | B5 | | | | |
| Ex. B6 | Toner | A | A | A | A |
| | B6 | | | | |
| Ex. B7 | Toner | A | B | A | C |
| | B7 | | | | |
| Comp. Ex. | Toner | A | B | A | D |
| B1 | B8 | | | | |
| Comp. Ex. | Toner | D | B | A | A |
| B2 | B9 | | | | |
| Comp. Ex. | Toner | A | D | B | D |
| B3 | B10 | | | | |

### Examples of Toners According to Third Embodiment

### —Synthesis of Fumaric Acid-Modified Rosin A—

In a 10 L volumetric flask equipped with a distilling tube, a reflux condenser and a receiver, 5,408 g (16 mol) of a purified rosin (SP value: 76.8° C.), 928 g (8 mol) of fumaric acid, and 0.4 g of t-butylcatecol were added. After heating from 160° C. to 200° C. over 2 hours, the reaction was performed at 200° C. for 2 hours and distillation was performed under reduced pressure of 5.3 kPa to obtain a fumaric acid-modified rosin A. The resulting fumaric acid-modified rosin A was found to have an SP value of 130.8° C. and a glass transition temperature of 74.4° C., and the degree of modification with fumaric acid was 100.

### —Synthesis of Fumaric Acid-Modified Rosin B—

In a 10 L volumetric flask equipped with a distilling tube, a reflux condenser and a receiver, 5,408 g (16 mol) of a purified rosin (SP value: 76.8° C.), 557 g (4.8 mol) of fumaric acid, and 0.4 g of t-butylcatecol were added. After heating from 160° C. to 200° C. over 2 hours, the reaction was performed at 200° C. for 2 hours and distillation was performed under reduced pressure of 5.3 kPa to obtain a fumaric acid-modified rosin B. The resulting fumaric acid-modified rosin B was found to have an SP value of 115.7° C. and a glass transition temperature of 53.9° C., and the degree of modification with fumaric acid was 72.

### —Synthesis of Fumaric Acid-Modified Rosin C—

In a 10 L volumetric flask equipped with a distilling tube, a reflux condenser and a receiver, 5,408 g (16 mol) of a purified rosin (SP value: 76.8° C.), 278 g (2.4 mol) of fumaric acid, and 0.4 g of t-butylcatecol were added. After heating from 160° C. to 200° C. over 2 hours, the reaction was performed at 200° C. for 2 hours and distillation was performed under reduced pressure of 5.3 kPa to obtain a fumaric acid-modified rosin C. The resulting fumaric acid-modified rosin C was found to have an SP value of 98.4° C. and a glass transition temperature of 48.3° C., and the degree of modification with fumaric acid was 40.

### —Synthesis of Fumaric Acid-Modified Rosin D—

In a 10 L volumetric flask equipped with a distilling tube, a reflux condenser and a receiver, 5,312 g (16 mol) of an unpurified rosin (SP value: 77.0° C.), 928 g (8 mol) of fumaric acid, and 0.4 g of t-butylcatecol were added. After heating from 160° C. to 200° C. over 2 hours, the reaction was performed at 200° C. for 2 hours and distillation was performed under reduced pressure of 5.3 kPa to obtain a fumaric acid-modified rosin D. The resulting fumaric acid-modified rosin D was found to have an SP value of 130.4° C. and a glass transition temperature of 72.1° C., and the degree of modification with fumaric acid was 100.

### —Synthesis of Polyester-Based Binder Resins D1 to D8 (Polyester Resins (A))—

An alcohol component, a carboxylic acid component other than trimellitic anhydride, and an esterifying catalyst shown in Table 11-A were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then the reaction was performed at 230° C. under 8 kPa for one hour. After cooling to 220° C., trimellitic anhydride shown in Table 11-A was charged and the reaction was performed under a normal pressure (101.3 kPa) for one hour, and then the reaction was performed at 220° C. under 20 kPa until the temperature reached a desired softening point, and thus polyester-based binder resins D1 to D8 were synthesized. The acid value, the hydroxyl value, the softening point, the glass transition temperature, and the contained amount of a low molecular weight component having a molecular weight of 500 or less of each of the resulting polyester resins D1 to D8 were measured according to the measurement methods described above. The measurement results are also shown in Table 11-B.

TABLE 11-A

| | | Polyester Resin No. | | | | | | | |
|---|---|---|---|---|---|---|---|---|---|
| | | D1 | D2 | D3 | D4 | D5 | D6 | D7 | D8 |
| Alcohol | 1,2-propanediol | 889 g | 889 g | 1,254 g | 740 g | 721 g | 889 g | 889 g | 1,064 g |
| component | 1,3-propanediol | 258 g | 258 g | — | — | — | 258 g | 258 g | — |
| | 1,4-butanediol | — | — | — | 252 g | — | — | — | — |
| | BPA-PO* | — | — | — | — | 882 g | — | — | — |
| | glycerin | 166 g | 166 g | — | 135 g | — | 166 g | 166 g | — |
| Carboxylic | terephthalic acid | 2,108 g | 2,108 g | 2,054 g | 1,809 g | 1,195 g | 2,108 g | 2,108 g | 1,720 g |
| acid | trimellitic anhydride | 307 g | 307 g | 380 g | 100 g | 277 g | 307 g | 307 g | 54 g |
| component | unpurified rosin | — | — | — | — | — | — | — | 1,027 g |
| | fumaric acid-modified | 580 g | — | 192 g | 667 g | 708 g | — | — | — |
| | rosin A | | | | | | | | |
| | fumaric acid-modified | — | 580 g | — | — | — | — | — | — |
| | rosin B | | | | | | | | |
| | fumaric acid-modified | — | — | — | — | — | — | 580 g | — |
| | rosin C | | | | | | | | |
| | fumaric acid-modified | — | — | — | — | — | 590 g | — | — |
| | rosin D | | | | | | | | |
| Esterifying | butyltin oxide | — | — | 15 g | — | 20 g | — | — | — |
| catalyst | tin (II) 2-ethylhexanoate | 20 g | 20 g | — | — | — | 20 g | 20 g | 20 g |
| | titanium diisopropylate | — | — | — | 25 g | — | — | — | — |
| | bis(triethanol aminate) | | | | | | | | |

| | | | | | | | | |
|---|---|---|---|---|---|---|---|---|
| Amount of rosin contained in | 19.4 | 19.4 | 7.3 | 25.9 | 32.5 | 19.6 | 19.4 | 36.7 |
| carboxylic acid component (% by mass) | | | | | | | | |

TABLE 11-B

| | | Polyester Resin No. | | | | | | | |
|---|---|---|---|---|---|---|---|---|---|
| | | D1 | D2 | D3 | D4 | D5 | D6 | D7 | D8 |
| Physical | Acid value (mgKOH/g) | 27.8 | 26.9 | 58.9 | 53.6 | 29.4 | 73.2 | 18.5 | 28.4 |
| properties | Hydroxyl value (mgKOH/g) | 25.2 | 24.3 | 45.8 | 24.3 | 22.4 | 65.8 | 11.4 | 21.2 |
| of | Softening point (° C.) | 138.9 | 125.0 | 104.3 | 119.2 | 111.8 | 120.3 | 115.6 | 105.9 |
| polyester | Glass transition | 65.2 | 63.8 | 57.4 | 60.2 | 63.8 | 70.4 | 63.9 | 54.9 |
| resin | temperature (° C.) | | | | | | | | |
| | Amount of low-molecular | 6.5 | 8.1 | 8.6 | 7.5 | 7.8 | 5.8 | 9.5 | 14.2 |
| | weight component having | | | | | | | | |
| | molecular weight of 500 or | | | | | | | | |
| | less (%) | | | | | | | | |

* Unpurified rosin: unmodified rosin
* BPA-PO: propylene oxide adduct of bisphenol A, polyoxypropylene(2.2)-2,2-bis(4-hydroxyphenyl)propane

### —Synthesis of Polyester Resins E1 to E7 (Polyester Resins (B))—

An alcohol component, a carboxylic acid component other than trimellitic anhydride, and an esterifying catalyst shown in Table 12 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then the reaction was performed at 230° C. under 8 kPa for one hour. After cooling to 220° C., trimellitic anhydride shown in Table 12 was charged and the reaction was performed under a normal pressure (101.3 kPa) for one hour, and then the reaction was performed at 220° C. under 20 kPa until the temperature reached a desired softening point, and thus polyester resins E1 to E7 were obtained. The softening point, glass transition temperature, and acid value of each of the resulting polyester resins E1 to E7 were measured. The measurement results are also shown in Table 12.

TABLE 12

| | | Polyester Resin No. | | | | | | |
|---|---|---|---|---|---|---|---|---|
| | | E1 | E2 | E3 | E4 | E5 | E6 | E7 |
| Alcohol | BPA-PO* | 517 g | 517 g | — | — | 258 g | 517 g | 517 g |
| component | BPF-PO* | — | — | 380 g | 380 g | — | — | — |
| | 1,2-propanediol | — | — | 23 g | 23 g | 57 g | — | — |
| Carboxylic acid | terephthalic acid | 125 g | 125 g | 125 g | 125 g | 150 g | 125 g | 150 g |
| | itaconic acid | 78 g | 78 g | 78 g | 78 g | 39 g | 78 g | 39 g |
| component | trimellitic anhydride | 144 g | 144 g | 144 g | 144 g | 173 g | 144 g | 173 g |
| Esterifying | tin (II) | 6 g | 4 g | 4 g | 3 g | 4 g | 8 g | 4 g |
| catalyst | 2-ethylhexanoate | | | | | | | |
| Amount of bisphenol compound | | 100 | 100 | 80 | 80 | 50 | 100 | 100 |
| contained in alcohol component | | | | | | | | |
| Physical | Softening point | 119.4 | 112.0 | 80.3 | 76.5 | 111.7 | 122.3 | 118.5 |
| properties | (° C.) | | | | | | | |
| of polyester | Glass transition | 61.2 | 60.6 | 57.2 | 55.3 | 60.3 | 62.3 | 62.1 |
| resin | temperature (° C.) | | | | | | | |
| | Acid value | 10.2 | 10.4 | 5.6 | 6.7 | 13.3 | 13.5 | 27.8 |
| | (mgKOH/g) | | | | | | | |

* BPA-PO: propylene oxide adduct of bisphenol A, polyoxypropylene(2.2)-2,2-bis(4-hydroxyphenyl)propane
* BPF-PO: propylene oxide adduct of bisphenol F, polyoxypropylene(2.2)-2,2-bis(4-hydroxyphenyl)methane

### Examples C1 to C22 and Comparative Example C1 to C2

### —Production of Toner—

Components of the combination of a binder resin, a releasing agent and a colorant (type and formulation amount) shown in Table 13 were premixed using a HENSCHEL MIXER (manufactured by Mitsui Miike Kakouki Co., Ltd., FM10B) and melted and kneaded by a biaxial kneader (manufactured by IKEGAI, LTD., PCM-30) at a temperature of 100° C. to 130° C. The resulting kneaded product was cooled to the room temperature and then coarsely crushed to particle sizes of 200 μm to 300 μm by a hammer mill. Next, the crushed particles were finely pulverized by a supersonic jet pulverizer (LABOJET, manufactured by Nihon Pneumatic Industry Co., Ltd.) while appropriately adjusting a pulverizing air pressure so as to have mass average particle diameters of 8.2 μm±0.3 μm, and then classified by an air classifier (manufactured by Nihon Pneumatic Industry Co., Ltd., MDS-I) while appropriately adjusting its louver opening so that the mass average particle diameters were 9.0 μm±0.2 μm and the amount of fine powder particles having particle diameters of 4 μm or less was 10% by number or less, and thus toner base particles were obtained. Next, an additive (HDK-2000, produced by Clariant Japan K.K.) in an amount of 1.0 part by mass to 100 parts by mass of the toner base particles was stirred and mixed with each other in a HENSCHEL MIXER, thereby producing Toners C1 to C24, respectively.

TABLE 13

| | | Binder Resin | | | | | | | |
|---|---|---|---|---|---|---|---|---|---|
| | Toner | Polyester resin (A) | | Polyester resin (B) | | Releasing agent | | Colorant | |
| Ex. C1 | Toner C1 | Resin D1 | 50 parts | Resin E1 | 50 parts | carnauba wax | 5 parts | carbon black | 8 parts |
| Ex. C2 | Toner C2 | Resin D1 | 50 parts | Resin E2 | 50 parts | carnauba wax | 5 parts | carbon black | 8 parts |
| Ex. C3 | Toner C3 | Resin D1 | 50 parts | Resin E3 | 50 parts | carnauba wax | 5 parts | carbon black | 8 parts |
| Ex. C4 | Toner C4 | Resin D2 | 50 parts | Resin E1 | 50 parts | carnauba wax | 5 parts | carbon black | 8 parts |
| Ex. C5 | Toner C5 | Resin D2 | 50 parts | Resin E2 | 50 parts | carnauba wax | 5 parts | carbon black | 8 parts |
| Ex. C6 | Toner C6 | Resin D2 | 50 parts | Resin E3 | 50 parts | carnauba wax | 5 parts | carbon black | 8 parts |
| Ex. C7 | Toner C7 | Resin D3 | 50 parts | Resin E1 | 50 parts | carnauba wax | 5 parts | carbon black | 8 parts |
| Ex. C8 | Toner C8 | Resin D3 | 50 parts | Resin E2 | 50 parts | carnauba wax | 5 parts | carbon black | 8 parts |
| Ex. C9 | Toner C9 | Resin D3 | 50 parts | Resin E3 | 50 parts | carnauba wax | 5 parts | carbon black | 8 parts |
| Ex. C10 | Toner C10 | Resin D4 | 50 parts | Resin E1 | 50 parts | carnauba wax | 5 parts | carbon black | 8 parts |
| Ex. C11 | Toner C11 | Resin D4 | 50 parts | Resin E2 | 50 parts | carnauba wax | 5 parts | carbon black | 8 parts |
| Ex. C12 | Toner C12 | Resin D4 | 50 parts | Resin E3 | 50 parts | carnauba wax | 5 parts | carbon black | 8 parts |
| Ex. C13 | Toner C13 | Resin D3 | 90 parts | Resin E3 | 10 parts | carnauba wax | 5 parts | carbon black | 8 parts |
| Ex. C14 | Toner C14 | Resin D2 | 40 parts | Resin E3 | 60 parts | carnauba wax | 5 parts | carbon black | 8 parts |
| Ex. C15 | Toner C15 | Resin D2 | 30 parts | Resin E3 | 70 parts | carnauba wax | 5 parts | carbon black | 8 parts |
| Ex. C16 | Toner C16 | Resin D2 | 50 parts | Resin E4 | 50 parts | carnauba wax | 5 parts | carbon black | 8 parts |
| Ex. C17 | Toner C17 | Resin D2 | 50 parts | Resin E5 | 50 parts | carnauba wax | 5 parts | carbon black | 8 parts |
| Ex. C18 | Toner C18 | Resin D2 | 50 parts | Resin E6 | 50 parts | carnauba wax | 5 parts | carbon black | 8 parts |
| Ex. C19 | Toner C19 | Resin D2 | 50 parts | Resin E7 | 50 parts | carnauba wax | 5 parts | carbon black | 8 parts |
| Ex. C20 | Toner C20 | Resin D5 | 50 parts | Resin E3 | 50 parts | carnauba wax | 5 parts | carbon black | 8 parts |
| Ex. C21 | Toner C21 | Resin D6 | 50 parts | Resin E3 | 50 parts | carnauba wax | 5 parts | carbon black | 8 parts |
| Ex. C22 | Toner C22 | Resin D7 | 50 parts | Resin E3 | 50 parts | carnauba wax | 5 parts | carbon black | 8 parts |
| Comp. Ex. C1 | Toner C23 | Resin D2 | 100 parts | — | — | carnauba wax | 5 parts | carbon black | 8 parts |
| Comp. Ex. C2 | Toner C24 | Resin D8 | 50 parts | Resin E3 | 50 parts | carnauba wax | 5 parts | carbon black | 8 parts |

### —Preparation of Carrier—

According to the following coating material formulation, components were dispersed by a stirrer for 10 minutes to prepare a coating liquid. This coating liquid and 5,000 parts by mass of a core material (Cu—Zn ferrite particle, mass average particle diameter=80 μm) were charged in a coating device for coating while forming a spinning stream, equipped with a fluidized bed, a rotary bottom plate disc and a stirring blade disc arranged in the fluidized bed, and the coating material was coated with the coating liquid. The resulting coated core material was baked in an electric furnace at 280° C. for 2 hours to prepare a carrier.

### [Composition of Coating Material]

| | |
|---|---|
| toluene | 450 parts by mass |
| silicone resin (SR2400, produced by TORAY Dow | 450 parts by mass |
| Corning Silicone Co., Ltd., nonvolatile content: | |
| 50% by mass) | |
| aminosilane (SH6020, produced by TORAY Dow | 10 parts by mass |
| Corning Silicone) | |
| carbon black | 10 parts by mass |

### —Preparation of Two-Component Developer—

Each of 5% by mass of Toners C1 to C24 thus obtained and 95% by mass of the carrier thus obtained were uniformly mixed and triboelectrically charged using a tubular mixer (manufactured by Willy A. Bachofen (WAB) AG Maschinenfabrik) at 48 rpm for 5 minutes to prepare two-component developers C1 to C24.

### —Evaluation of Physical Properties—

Next, Toners of Examples and Comparative Examples C1 to C24 were evaluated for pulverizability, heat resistant storage stability, cold offset resistance, hot offset resistance, smear resistance, and odor property, according to the following evaluation methods and evaluation criteria. The evaluation results are shown in Table 14.

Note that smear resistance, cold offset resistance, and hot offset resistance were evaluated after each of the developers C1 to C24 of Examples and Comparative Examples had been charged in an image forming apparatus.

Here, as the image forming apparatus, a remodeled machine of a super high-speed digital laser printer, IPSIO SP9500PRO (manufactured by Ricoh Company Ltd., printing speed: 156 sheets/min (A4 size paper sheet, fed into the printing section from its longer side) employing a two-component developing method and a direct transfer method and a heat roller fixing method was used.

### <Pulverizability>

A molten kneaded product of the toner raw material obtained in the production of the toners of Examples and Comparative Examples was coarsely crushed by a hammer mill to 200 μm to 300 μm, and 10.00 g (precisely weighed) of the crushed powder was pulverized in a mill & mixer Model MM-I (manufactured by Hitachi Living Systems) for 30 seconds, and then sieved through a sieve of 30 mesh (sieve opening size: 500 μm). A mass (A) g of the resin that had not been passed through the sieve was precisely weighed, and the residual rate of the toner raw material was determined from the following Equation (i). This operation was repeated three times, and an average value of the residual rates was used an indicator of pulverizability. Then, evaluation for pulverizability was carried out according to the following evaluation criteria. The smaller the average value of residual rate is, the more excellent pulverizability is.

Residual Rate (%)=[(A)/mass of toner before being pulverized (10.00 g)]×100 [Equation (i)]

### [Evaluation Criteria]

A: The residual rate was less than 3%.

B: The residual rate was 3% or more and less than 8%.

C: The residual rate was 8% or more and less than 15% (which is as same as the residual rates obtained from conventional toners).

D: The residual rate was 15% or more and less than 20%.

E: The residual rate was 20% or more.

### <Heat Resistant Storage Stability>

The heat resistant storage stability was measured using a needle penetration tester (manufactured by Nihon Kagaku Engineering K.K.). More specifically, each of the toners was weighed in an amount of 10 g and put in a 30 ml glass vial (screw vial) under an environment of a temperature of 20° C. to 25° C. and a relative humidity of 40% to 60% and the vial was sealed with a lid. The glass vial containing the toner was tapped 200 times and then left standing in a thermostatic bath maintained at a temperature of 50° C. for 48 hours. Then, a degree of penetration was measured by the needle penetration tester, and the evaluation for heat resistant storage stability was carried out according to the following criteria. The greater the value of degree of penetration is, the more excellent heat resistant storage stability is.

### [Evaluation Criteria]

A: The degree of penetration was 30 mm or more.

B: The degree of penetration was 20 mm or more and less than 30 mm.

C: The degree of penetration was 15 mm or more and less than 20 mm (which is as same as the rates of penetration obtained from conventional toners).

D: The degree of penetration was 8 mm or more and less than 15 mm.

E: The degree of penetration was less than 8 mm.

### <Cold Offset Resistance>

Each of the developers was charged in a super high-speed digital laser printer, IPSIO SP9500PRO, and a solid image having a size of 1 cm square was formed on a transfer sheet of heavy paper (produced by NBS Ricoh Co., Ltd., copy print paper <135>) with a toner adhesion amount of 0.20 mg/cm²+0.1 mg/cm². A “Scotch Mending Tape 810” (tape width=24 mm, produced by Sumitomo 3M Ltd.) was attached on the solid image, and a metal roller (made of SUS; diameter 50 mm) having a weight of 1 kg was rolled back and forth 10 times over the tape at a rolling speed of 10 mm/s. The tape was peeled off in a given direction at a speed of 10 mm/s, and an image residual rate was determined from the results of image density before and after the peeling off of the tape, using the following Equation (ii), and the evaluation for cold offset resistance was carried out according to the following evaluation criteria.

Image Residual Rate (%)=(Image density after peeling of tape/Image density before peeling of tape)×100 Equation (ii)

### [Evaluation Criteria]

A: The image residual rate was 97% or more.

B: The image residual rate was 92% or more and less than 97%.

C: The image residual rate was 85% or more and less than 92%.

D: The image residual rate was 80% or more and less than 85% (which is as same as the image rates obtained from conventional toners).

E: The image residual rate was less than 80%.

### <Hot Offset Resistance>

Each of the developers was charged in a super high-speed digital laser printer, IPSIO SP9500PRO, and a solid image having a size of 1 cm square was formed on a transfer sheet of thin paper (produced by NBS Ricoh Co., Ltd., copy print paper <55>) with a toner adhesion amount of 0.40 mg/cm²±0.1 mg/cm². The image was fixed while varying the fixing roller temperature, and presence or absence of hot offset was visually observed. An upper limit temperature at which no hot offset occurred was determined as an upper limit fixing temperature, and the evaluation for hot offset resistance was carried out according to the following evaluation criteria.

### [Evaluation Criteria]

A: The upper limit fixing temperature was 240° C. or more.

B: The upper limit fixing temperature was 220° C. or more and less than 240° C.

C: The upper limit fixing temperature was 200° C. or more and less than 220° C.

D: The upper limit fixing temperature was 180° C. or more and less than 200° C. (which is as same as the upper limit temperatures of conventional toners).

E: The upper limit fixing temperature was less than 180° C.

### <Smear Resistance on Developing Roller>

Each of the developers was charged in a super high-speed digital laser printer, IPSIO SP9500PRO, and a running printing test of 100,000 sheets was performed using an image chart having an image area ratio of 5%. After the running printing test, the developer and toner on the developing roller were removed therefrom, and the evaluation for smear resistance on developing roller was carried out by visually observing smear on the surface of the developing roller in the paper passing part.

### [Evaluation Criteria]

A: No smear observed on the developing roller.

B: A slight amount of smear occurred, but it was difficult to visually distinguish.

C: A small amount of smear occurred.

D: Considerable smear occurred (which is on the substantially same level as those of conventional toners).

E: Considerable smear occurred and it was difficult to put into practical use.

### <Evaluation Method for Odor of Toner>

Each of the toners was weighed in an amount of 20 g in an aluminum cup, the cup was left standing for 30 minutes on a hot plate which was heated at 150° C., and odor generated from the toner was evaluated according to the following evaluation criteria.

### [Evaluation Criteria]

A: No odor was detected.

B: Almost no odor was detected.

C: Odor was slightly detected, but no problem in practical use.

D: Strong odor was detected.

TABLE 14

| | | | Heat resistant | | | Smear | |
|---|---|---|---|---|---|---|---|
| | | | storage | Cold offset | Hot offset | resistance on | |
| | Toner | Pulverizability | stability | resistance | resistance | developing roller | Odor |
| Ex. C1 | Toner C1 | B | A | B | A | A | A |
| Ex. C2 | Toner C2 | B | B | B | A | A | A |
| Ex. C3 | Toner C3 | B | B | A | B | B | A |
| Ex. C4 | Toner C4 | B | A | B | A | A | B |
| Ex. C5 | Toner C5 | B | B | B | B | B | B |
| Ex. C6 | Toner C6 | A | B | A | B | B | B |
| Ex. C7 | Toner C7 | A | B | A | B | A | A |
| Ex. C8 | Toner C8 | A | B | A | B | B | A |
| Ex. C9 | Toner C9 | A | B | A | B | B | A |
| Ex. C10 | Toner C10 | B | A | B | A | A | B |
| Ex. C11 | Toner C11 | B | B | B | A | A | B |
| Ex. C12 | Toner C12 | A | B | A | B | B | B |
| Ex. C13 | Toner C13 | A | B | A | B | B | A |
| Ex. C14 | Toner C14 | B | A | A | B | B | A |
| Ex. C15 | Toner C15 | B | B | C | B | B | A |
| Ex. C16 | Toner C16 | A | C | B | C | C | A |
| Ex. C17 | Toner C17 | A | C | B | B | C | A |
| Ex. C18 | Toner C18 | B | A | C | A | A | A |
| Ex. C19 | Toner C19 | B | B | C | C | B | A |
| Ex. C20 | Toner C20 | C | B | C | B | A | A |
| Ex. C21 | Toner C21 | B | B | C | C | B | C |
| Ex. C22 | Toner C22 | B | C | B | C | B | B |
| Comp. Ex. C1 | Toner C23 | B | B | D | B | E | A |
| Comp. Ex. C2 | Toner C24 | A | E | A | C | D | D |

The results shown in Table 14 demonstrated that as compared to Comparative Examples C1 and C2, Examples C1 to C22 are more capable of achieving low-temperature fixability, offset resistance and heat resistant storage stability on the level suitable for use in super high-speed image forming systems, reducing the generation of odor, and are excellent in smear resistance on developing roller etc., and in pulverizability.

### Examples of Toners According to Fourth Embodiment

### <Measurement of Saturated SP Value of Maleic Acid-Modified Rosin Using Unpurified Rosin>

In a 1,000 ml volumetric flask equipped with a distilling tube, a reflux condenser and a receiver, 332 g (1 mol) of an unpurified rosin (SP value: 77.0° C.) and 98 g (1 mol) of maleic anhydride were added. After heating from 160° C. to 230° C. over 8 hours, it was confirmed that an SP value did not increase at 230° C. and the unreacted maleic anhydride and a low boiling point substance were distilled away under reduced pressure of 5.3 kPa to obtain a maleic acid-modified rosin. An SP value of the resulting maleic acid-modified rosin, that is, a saturated SP value of a maleic acid-modified rosin using an unpurified rosin was 116° C.

### <Measurement of Saturated SP Value of Maleic Acid-Modified Rosin Using Purified Rosin>

In a 1,000 ml volumetric flask equipped with a distilling tube, a reflux condenser and a receiver, 338 g (1 mol) of a purified rosin (SP value: 76.8° C.) and 98g (1 mol) of maleic anhydride were added. After heating from 160° C. to 230° C. over 8 hours, it was confirmed that an SP value did not increase at 230° C. and the unreacted maleic anhydride and a low boiling point substance were distilled away under reduced pressure of 5.3 kPa to obtain a maleic acid-modified rosin. An SP value of the resulting maleic acid-modified rosin, that is, a saturated SP value of a maleic acid-modified rosin using a purified rosin was 116° C.

### —Synthesis of Maleic Acid-Modified Rosin A—

In a 10 L volumetric flask equipped with a distilling tube, a reflux condenser and a receiver, 6,084 g (18 mol) of a purified rosin (SP value: 76.8° C.) and 1,234.8 g (12.6 mol) of maleic anhydride were added. After heating from 160° C. to 220° C. over 8 hours, the reaction was performed at 220° C. for 2 hours and distillation was performed under reduced pressure of 5.3 kPa to obtain a maleic acid-modified rosin A. An SP value of the resulting maleic acid-modified rosin A was 116° C. and the degree of modification with maleic acid was 100.

### —Synthesis of Maleic Acid-Modified Rosin B—

In a 10 L volumetric flask equipped with a distilling tube, a reflux condenser and a receiver, 6,084 g (18 mol) of a purified rosin (SP value: 76.8° C.) and 882 g (9 mol) of maleic anhydride were added. After heating from 160° C. to 220° C. over 8 hours, the reaction was performed at 220° C. for 2 hours and distillation was performed under reduced pressure of 5.3 kPa to obtain a maleic acid-modified rosin B. An SP value of the resulting maleic acid-modified rosin B was 106.2° C. and the degree of modification with maleic acid was 75.

### —Synthesis of Maleic Acid-Modified Rosin C—

In a 10 L volumetric flask equipped with a distilling tube, a reflux condenser and a receiver, 6,084 g (18 mol) of a purified rosin (SP value: 76.8° C.) and 529 g (5.4 mol) of maleic anhydride were added. After heating from 160° C. to 220° C. over 8 hours, the reaction was performed at 220° C. for 2 hours and distillation was performed under reduced pressure of 5.3 kPa to obtain a maleic acid-modified rosin C. An SP value of the resulting maleic acid-modified rosin C was 96.4° C. and the degree of modification with maleic acid was 50.

### —Synthesis of Maleic Acid-Modified Rosin D—

In a 10 L volumetric flask equipped with a distilling tube, a reflux condenser and a receiver, 6,084 g (18 mol) of a purified rosin (SP value: 76.8° C.) and 352.8 g (3.6 mol) of maleic anhydride were added. After heating from 160° C. to 220° C. over 8 hours, the reaction was performed at 220° C. for 2 hours and distillation was performed under reduced pressure of 5.3 kPa to obtain a maleic acid-modified rosin D. An SP value of the resulting maleic acid-modified rosin D was 88.6° C. and the degree of modification with maleic acid was 30.

### —Synthesis of Maleic Acid-Modified Rosin E—

In a 10 L volumetric flask equipped with a distilling tube, a reflux condenser and a receiver, 5,976 g (18 mol) of an unpurified rosin (SP value: 77.0° C.) and 352.8 g (3.6 mol) of maleic anhydride were added. After heating from 160° C. to 220° C. over 8 hours, the reaction was performed at 250° C. for 2 hours and distillation was performed under reduced pressure of 5.3 kPa to obtain a maleic acid-modified rosin E. An SP value of the resulting maleic acid-modified rosin E was 88.7° C. and the degree of modification with maleic acid was 30.

### —Synthesis of Maleic Acid-Modified Rosin F—

In a 10 L volumetric flask equipped with a distilling tube, a reflux condenser and a receiver, 5,976 g (18 mol) of an unpurified rosin (SP value: 77.0° C.) and 352.8 g (3.6 mol) of maleic anhydride were added. After heating from 160° C. to 220° C. over 8 hours, the reaction was performed at 250° C. for 2 hours and distillation was performed under reduced pressure of 5.3 kPa to obtain a maleic acid-modified rosin F. An SP value of the resulting maleic acid-modified rosin F was 83.8° C. and the degree of modification with maleic acid was 17.

Next, polyester-based binder resins (A) were synthesized using an alcohol component, a carboxylic acid component containing each of the maleic acid-modified rosins synthesized above, and an esterifying catalyst.

### —Synthesis of Polyester-Based Binder Resins F1 to F4—

An alcohol component, a carboxylic acid component other than trimellitic anhydride, and an esterifying catalyst shown in Table 15 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then the reaction was performed at 230° C. under 8 kPa for one hour. After cooling to 220° C., trimellitic anhydride shown in Table 15 was charged and the reaction was performed under a normal pressure (101.3 kPa) for one hour, and then the reaction was performed at 220° C. under 20 kPa until the temperature reached a desired softening point, and thus polyester-based binder resins F1 to F4 were synthesized.

Note that in the polyester-based binder resins F1 to F4, the amount of a divalent aliphatic alcohol having 2 to 6 carbon atoms contained in a divalent alcohol component was 100 mole %, and the amount of the divalent aliphatic alcohol contained in an alcohol component was 100 mole %.

### —Synthesis of Polyester-Based Binder Resin F5—

An alcohol component, a carboxylic acid component other than trimellitic anhydride, and an esterifying catalyst shown in Table 15 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then the reaction was performed at 230° C. under 8 kPa until the temperature reached a desired softening point, and thus a polyester-based binder resin F5 was synthesized. Note that in the polyester-based binder resin F5, the amount of a divalent aliphatic alcohol having 2 to 6 carbon atoms contained in a divalent alcohol component was 74 mole %.

TABLE 15

| | | Polyester Resin No. | | | | |
|---|---|---|---|---|---|---|
| | | F1 | F2 | F3 | F4 | F5 |
| Alcohol | 1,2-propanediol | 457 g | 457 g | 457 g | 457 g | — |
| component | 1,3-propanediol | 114 g | 114 g | 114 g | 114 g | — |
| | ethylene glycol | — | — | — | — | 869 g |
| | BPA-PO* | — | — | — | — | 1,750 g |
| Carboxylic | terephthalic acid | 871.5 g | 871.5 g | 871.5 g | 871.5 g | 2,490 g |
| acid | trimellitic anhydride | 144 g | 144 g | 144 g | 144 g | — |
| component | maleic acid-modified rosin A | 603 g | — | — | — | — |
| | maleic acid-modified rosin B | — | 603 g | — | — | — |
| | maleic acid-modified rosin C | — | — | 603 g | — | — |
| | maleic acid-modified rosin D | — | — | — | 603 g | — |
| | maleic acid-modified rosin E | — | — | — | — | 776 g |
| | maleic acid-modified rosin F | — | — | — | — | — |
| Esterifying | tin (II) dioctanoate | 10 g | 10 g | 10 g | 10 g | 10 g |
| catalyst | | | | | | |
| Amount of rosin contained in | | 37.3 | 37.3 | 37.3 | 37.3 | 23.8 |
| carboxylic acid component (% by mass) | | | | | | |
| Amount of divalent aliphatic alcohol | | 100 | 100 | 100 | 100 | 70 |
| component having 2 to 6 carbon atoms in | | | | | | |
| divalent alcohol component (mole %) | | | | | | |
| Physical | Acid value (mgKOH/g) | 24.6 | 25.4 | 32.0 | 26.0 | 33.0 |
| properties | Softening point (° C.) | 142.0 | 146.4 | 141.8 | 135.8 | 120.0 |
| of | Glass transition | 66.5 | 67.0 | 62.3 | 62.0 | 61.0 |
| polyester | temperature (° C.) | | | | | |
| resin | Amount of low-molecular | 4.8 | 4.1 | 6.0 | 7.6 | 9.0 |
| | weight component having | | | | | |
| | molecular weight of 500 or | | | | | |
| | less (%) | | | | | |

*BPA-PO: polyoxypropylene(2.2)-2,2-bis(4-hydroxyphenyl)propane (divalent aromatic alcohol)

Next, polyester-based binder resins (B) were synthesized using an alcohol component containing an alkylene oxide adduct of a bisphenol compound represented by General Formula (1), and a carboxylic acid component.

### —Synthesis of Polyester Resins G1 to G7—

An alcohol component, a carboxylic acid component other than trimellitic anhydride, and an esterifying catalyst shown in Table 16 were charged in a 5 liter volumetric four-necked flask equipped with a nitrogen inlet tube, a dewatering tube, a stirrer and a thermocouple and the polycondensation reaction was performed under a nitrogen atmosphere at 230° C. for 10 hours, and then the reaction was performed at 230° C. under 8 kPa for one hour. After cooling to 220° C., trimellitic anhydride shown in Table 16 was charged and the reaction was performed under a normal pressure (101.3 kPa) for one hour, and then the reaction was performed at 220° C. under 20 kPa until the temperature reached a desired softening point, and thus polyester resins G1 to G7 were obtained. The softening point, glass transition temperature, and acid value of each of the resulting polyester resins are shown in Table 16.

TABLE 16

| | | Polyester Resin Formulation No. | | | | | | |
|---|---|---|---|---|---|---|---|---|
| | | G1 | G2 | G3 | G4 | G5 | G6 | G7 |
| Alcohol | BPA-PO* | 517 g | 517 g | — | — | 258 g | 517 g | 517 g |
| component | BPF-PO* | — | — | 380 g | 380 g | — | — | — |
| | 1,2-propanediol | — | — | 23 g | 23 g | 57 g | — | — |
| Carboxylic | terephthalic acid | 125 g | 125 g | 125 g | 125 g | 150 g | 125 g | 150 g |
| acid | itaconic acid | 78 g | 78 g | 78 g | 78 g | 39 g | 78 g | 39 g |
| component | trimellitic | 144 g | 144 g | 144 g | 144 g | 173 g | 144 g | 173 g |
| | anhydride | | | | | | | |
| Esterifying | tin (II) | 6 g | 4 g | 4 g | 4 g | 4 g | 8 g | 4 g |
| catalyst | 2-ethylhexanoate | | | | | | | |
| Amount of bisphenol compound | | 100 | 100 | 80 | 80 | 50 | 100 | 100 |
| contained in alcohol component | | | | | | | | |
| (mole %) | | | | | | | | |
| Physical | Softening point (° C.) | 155.4 | 112.0 | 90.2 | 87.9 | 111.7 | 162.3 | 118.5 |
| properties | Glass transition | 68.2 | 61.5 | 60.2 | 59.8 | 60.3 | 69.5 | 62.1 |
| of polyester | temperature (° C.) | | | | | | | |
| resin | Acid value | 10.2 | 10.4 | 5.6 | 6.7 | 13.3 | 13.5 | 27.8 |
| | (mgKOH/g) | | | | | | | |

* BPA-PO: propylene oxide adduct of bisphenol A, polyoxipropylene(2.2)-2,2-bis(4-hydroxyphenyl)propane
* BPF-PO: propylene oxide adduct of bisphenol F, polyoxypropylene(2.2)-2,2-bis(4-hydroxyphenyl)methane

Next, toners were produced using each of the polyester resins (A) thus synthesized, each of the polyester resins (B) thus synthesized, a colorant, a releasing agent, and the like.

### Examples D1 to D14 and Comparative Example D1

### —Production of Toner—

Components of the combination of a binder resin, a releasing agent and a colorant (type and formulation amount) shown in Table 17 were premixed using a HENSCHEL MIXER (manufactured by Mitsui Miike Kakouki Co., Ltd., FM10B) and melted and kneaded by a biaxial kneader (manufactured by IKEGAI, LTD., PCM-30) at a temperature of 100° C. to 130° C. The resulting kneaded product was cooled to the room temperature and then coarsely crushed to particle sizes of 200 μm to 300 μm by a hammer mill. Next, the crushed particles were finely pulverized by a supersonic jet pulverizer (LABOJET manufactured by Nihon Pneumatic Industry Co., Ltd.) while appropriately adjusting a pulverizing air pressure so as to have mass average particle diameters of 8.2 μm±0.3 μm, and then classified by an air classifier (manufactured by Nihon Pneumatic Industry Co., Ltd., MDS-I) while appropriately adjusting its louver opening so that the mass average particle diameters were 9.0 μm±0.2 μm and the amount of fine powder particles having particle diameters of 4 μm or less was 10% by number or less, and thus toner base particles were obtained. Next, an additive (HDK-2000, produced by Clariant Japan K.K.) in an amount of 1.0 part by mass to 100 parts by mass of the toner base particles was stirred and mixed with each other in a HENSCHEL MIXER, thereby producing Toners D1 to D15, respectively.

TABLE 17

| | | Binder Resin | | | | | | | |
|---|---|---|---|---|---|---|---|---|---|
| | Toner | Polyester resin (A) | | Polyester resin (B) | | Releasing agent | | Colorant | |
| Ex. D1 | Toner D1 | Resin F1 | 50 parts | Resin G1 | 50 parts | carnauba wax | 5 parts | carbon black | 8 parts |
| Ex. D2 | Toner D2 | Resin F1 | 50 parts | Resin G2 | 50 parts | carnauba wax | 5 parts | carbon black | 8 parts |
| Ex. D3 | Toner D3 | Resin F1 | 50 parts | Resin G3 | 50 parts | carnauba wax | 5 parts | carbon black | 8 parts |
| Ex. D4 | Toner D4 | Resin F2 | 50 parts | Resin G1 | 50 parts | carnauba wax | 5 parts | carbon black | 8 parts |
| Ex. D5 | Toner D5 | Resin F3 | 50 parts | Resin G1 | 50 parts | carnauba wax | 5 parts | carbon black | 8 parts |
| Ex. D6 | Toner D6 | Resin F4 | 50 parts | Resin G1 | 50 parts | carnauba wax | 5 parts | carbon black | 8 parts |
| Ex. D7 | Toner D7 | Resin F5 | 50 parts | Resin G1 | 50 parts | carnauba wax | 5 parts | carbon black | 8 parts |
| Ex. D8 | Toner D8 | Resin F1 | 90 parts | Resin G1 | 10 parts | carnauba wax | 5 parts | carbon black | 8 parts |
| Ex. D9 | Toner D9 | Resin F1 | 40 parts | Resin G1 | 60 parts | carnauba wax | 5 parts | carbon black | 8 parts |
| Ex. D10 | Toner D10 | Resin F1 | 30 parts | Resin G1 | 70 parts | carnauba wax | 5 parts | carbon black | 8 parts |
| Ex. D11 | Toner D11 | Resin F1 | 50 parts | Resin G4 | 50 parts | carnauba wax | 5 parts | carbon black | 8 parts |
| Ex. D12 | Toner D12 | Resin F1 | 50 parts | Resin G5 | 50 parts | carnauba wax | 5 parts | carbon black | 8 parts |
| Ex. D13 | Toner D13 | Resin F1 | 50 parts | Resin G6 | 50 parts | carnauba wax | 5 parts | carbon black | 8 parts |
| Ex. D14 | Toner D14 | Resin F1 | 50 parts | Resin G7 | 50 parts | carnauba wax | 5 parts | carbon black | 8 parts |
| Comp. | Toner D15 | Resin F1 | 100 parts | — | — | carnauba wax | 5 parts | carbon black | 8 parts |
| Ex. D1 | | | | | | | | | |

### —Preparation of Carrier—

According to the following coating material formulation, components were dispersed by a stirrer for 10 minutes to prepare a coating liquid. This coating liquid and 5,000 parts by mass of a core material (Cu—Zn ferrite particle, mass average particle diameter=80 μm) were charged in a coating device for coating while forming a spinning stream, equipped with a fluidized bed, a rotary bottom plate disc and a stirring blade disc arranged in the fluidized bed, and the coating material was coated with the coating liquid. The resulting coated core material was baked in an electric furnace at 280° C. for 2 hours to prepare a carrier.

### [Composition of Coating Material]

| | |
|---|---|
| toluene | 450 parts by mass |
| silicone resin (SR2400, produced by TORAY Dow | 450 parts by mass |
| Corning Silicone Co., Ltd., nonvolatile content: | |
| 50% by mass) | |
| aminosilane (SH6020, produced by TORAY Dow | 10 parts by mass |
| Corning Silicone) | |
| carbon black | 10 parts by mass |

### —Preparation of Two-Component Developer—

Each of 5% by mass of Toners D1 to D15 thus obtained and 95% by mass of the carrier thus obtained were uniformly mixed and triboelectrically charged using a tubular mixer (manufactured by Willy A. Bachofen (WAB) AG Maschinenfabrik) at 48 rpm for 5 minutes to prepare two-component developers D1 to D18.

### —Evaluation of Physical Properties—

Next, Toners of Examples and Comparative Examples D1 to D15 were evaluated for pulverizability, cold offset resistance, hot offset resistance, smear resistance on developing roller, heat resistant storage stability and odor property. The evaluation results are shown in Table 18.

Note that smear resistance, cold offset resistance, and hot offset resistance were evaluated after each of the developers of Examples and Comparative Examples D1 to D15 had been charged in an image forming apparatus.

Here, as the image forming apparatus, a remodeled machine of a super high-speed digital laser printer, IPSIO SP9500PRO (manufactured by Ricoh Company Ltd., printing speed: 156 sheets/min (A4 size paper sheet, fed into the printing section from its longer side) employing a two-component developing method and a direct transfer method and a heat roller fixing method was used.

### <Pulverizability>

A molten kneaded product of the toner raw material obtained in the production of the toners of Examples and Comparative Examples was coarsely crushed by a hammer mill to 200 μm to 300 μm, and 10.00 g (precisely weighed) of the crushed powder was pulverized in a mill & mixer Model MM-I (manufactured by Hitachi Living Systems) for 30 seconds, and then sieved through a sieve of 30 mesh (sieve opening size: 500 μm). A mass (A) g of the resin that had not been passed through the sieve was precisely weighed, and the residual rate of the toner raw material was determined from the following Equation (II). This operation was repeated three times, and an average value of the residual rates was used an indicator of pulverizability. Then, evaluation for pulverizability was carried out according to the following evaluation criteria. The smaller the average value of residual rate is, the more excellent pulverizability is.

Residual Rate (%)=[(A)/mass of toner before being pulverized (10.00 g)]×100 [Equation (II)]

### [Evaluation Criteria]

A: The residual rate was less than 3%.

B: The residual rate was 3% or more and less than 8%.

C: The residual rate was 8% or more and less than 15% (which is as same as the residual rates obtained from conventional toners).

D: The residual rate was 15% or more and less than 20%.

E: The residual rate was 20% or more.

### <Heat Resistant Storage Stability>

The heat resistant storage stability was measured using a needle penetration tester (manufactured by Nihon Kagaku Engineering K.K.). More specifically, each of the toners was weighed in an amount of 10 g and put in a 30 ml glass vial (screw vial) under an environment of a temperature of 20° C. to 25° C. and a relative humidity of 40% to 60% and the vial was sealed with a lid. The glass vial containing the toner was tapped 200 times and then left standing in a thermostatic bath maintained at a temperature of 50° C. for 48 hours. Then, a degree of penetration was measured by the needle penetration tester, and the evaluation for heat resistant storage stability was carried out according to the following criteria. The greater the value of degree of penetration is, the more excellent heat resistant storage stability is.

### [Evaluation Criteria]

A: The degree of penetration was 30 mm or more.

B: The degree of penetration was 20 mm to 29 mm.

C: The degree of penetration was 15 mm to 19 mm (which is as same as the rates of penetration obtained from conventional toners).

D: The degree of penetration was 8 mm to 14 mm.

E: The degree of penetration was 7 mm or less.

### <Cold Offset Resistance>

Each of the developers was charged in a super high-speed digital laser printer, IPSIO SP9500PRO, and a solid image having a size of 1 cm square was formed on a transfer sheet of heavy paper (produced by NBS Ricoh Co., Ltd., copy print paper <135>) with a toner adhesion amount of 0.20 mg/cm²±0.1 mg/cm². A “Scotch Mending Tape 810” (tape width=24 mm, produced by Sumitomo 3M Ltd.) was attached on the solid image, and a metal roller (made of SUS; diameter 50 mm) having a weight of 1 kg was rolled back and forth 10 times over the tape at a rolling speed of 10 mm/s. The tape was peeled off in a given direction at a speed of 10 mm/s, and an image residual rate was determined from the results of image density before and after the peeling off of the tape, using the following Equation (III), and the evaluation for cold offset resistance was carried out according to the following evaluation criteria.

Image Residual Rate (%)=(Image density after peeling of tape/Image density before peeling of tape)×100 Equation (III)

### [Evaluation Criteria]

A: The image residual rate was 97% or more.

B: The image residual rate was 92% or more and less than 97%.

C: The image residual rate was 85% or more and less than 92%.

D: The image residual rate was 80% or more and less than 85% (which is as same as the image rates obtained from conventional toners).

E: The image residual rate was less than 80%.

### <Hot Offset Resistance>

Each of the developers was charged in a super high-speed digital laser printer, IPSIO SP9500PRO, and a solid image having a size of 1 cm square was formed on a transfer sheet of thin paper (produced by NBS Ricoh Co., Ltd., copy print paper <55>) with a toner adhesion amount of 0.40 mg/cm²±0.1 mg/cm². The image was fixed while varying the fixing roller temperature, and presence or absence of hot offset was visually observed. An upper limit temperature at which no hot offset occurred was determined as an upper limit fixing temperature, and the evaluation for hot offset resistance was carried out according to the following evaluation criteria.

### [Evaluation Criteria]

A: The upper limit fixing temperature was 240° C. or more.

B: The upper limit fixing temperature was 220° C. or more and less than 240° C.

C: The upper limit fixing temperature was 180° C. or more and less than 220° C. (which is as same as the upper limit temperatures of conventional toners).

E: The upper limit fixing temperature was less than 180° C.

### <Smear Resistance on Developing Roller>

Each of the developers was charged in a super high-speed digital laser printer, IPSIO SP9500PRO, and a running printing test of 100,000 sheets was performed using an image chart having an image area ratio of 5%. After the running printing test, the developer and toner on the developing roller were removed therefrom, and the evaluation for smear resistance on developing roller was carried out by visually observing smear on the surface of the developing roller in the paper passing part.

### [Evaluation Criteria]

A: No smear observed on the developing roller.

B: A slight amount of smear occurred, but it was difficult to visually distinguish.

C: A small amount of smear occurred (which is on the substantially same level as those of conventional toners).

E: Considerable smear occurred and it was difficult to put into practical use.

### <Evaluation Method for Odor of Toner>

Each of the toners was weighed in an amount of 20 g in an aluminum cup, the cup was left standing for 30 minutes on a hot plate which was heated at 150° C., and odor generated from the toner was evaluated according to the following evaluation criteria.

### [Evaluation Criteria]

A: No odor was detected.

B: Almost no odor was detected.

C: Odor was slightly detected, but no problem in practical use.

D: Strong odor was detected.

TABLE 18

| | | | Heat resistant | | | Smear | |
|---|---|---|---|---|---|---|---|
| | | | storage | Cold offset | Hot offset | resistance on | |
| | Toner | Pulverizability | stability | resistance | resistance | developing roller | Odor |
| Ex. D1 | Toner D1 | B | A | B | A | A | A |
| Ex. D2 | Toner D2 | B | B | B | B | B | A |
| Ex. D3 | Toner D3 | B | B | A | B | B | A |
| Ex. D4 | Toner D4 | B | A | B | B | A | A |
| Ex. D5 | Toner D5 | B | B | A | B | B | A |
| Ex. D6 | Toner D6 | B | A | B | A | A | A |
| Ex. D7 | Toner D7 | A | C | A | C | C | C |
| Ex. D8 | Toner D8 | A | C | B | C | C | A |
| Ex. D9 | Toner D9 | B | B | A | B | C | A |
| Ex. D10 | Toner D10 | B | B | C | B | B | A |
| Ex. D11 | Toner D11 | A | C | B | C | C | A |
| Ex. D12 | Toner D12 | A | C | B | B | C | A |
| Ex. D13 | Toner D13 | B | A | C | A | A | A |
| Ex. D14 | Toner D14 | B | C | B | C | C | A |
| Comp. Ex. D1 | Toner D15 | B | C | B | C | D | A |

The results shown in Table 18 demonstrated that as compared to Comparative Example D1, Examples D1 to D14 are more capable of achieving low-temperature fixability, offset resistance and heat resistant storage stability on the level suitable for use in super high-speed image forming systems, reducing the generation of odor, have noteworthy smear resistance on developing roller etc., and are excellent in productivity.

The toner and the developer of the present invention are favorably used in super high-speed printing systems which can be used, for example, in print on demand (POD) technology especially using an electrophotographic printing method, because they are capable of achieving low-temperature fixability, offset resistance and heat resistant storage stability on a level suitable for use in super high-speed image forming systems, reducing the occurrence of odor and which has remarkable effect of improving smear resistance on developing roller, fixing members and the like and are also excellent in pulverizability and productivity.

What is claimed is:

1. A toner comprising:
a binder resin, and
a colorant,
wherein the binder resin comprises a polyester resin (A) which is obtained by polycondensation of an alcohol component with a carboxylic acid component containing one of a purified rosin and a modified rosin, and a polyester resin (B) which is obtained by polycondensation of a carboxylic acid with an alcohol component containing an alkylene oxide adduct of bisphenol A represented by General Formula (1) described below, and
wherein when a carboxylic acid component containing a purified rosin is used in the carboxylic acid component for the polyester resin (A), a mass ratio [(B)/(A)] of the polyester resin (B) to the polyester resin (A) is 2/8 to 6/4, 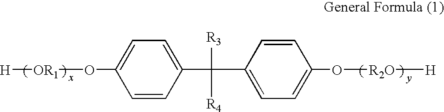
in General Formula (1), R₁ and R₂ are each an alkylene group having 2 to 4 carbon atoms, R₃ and R₄ are each any one of a hydrogen atom, a straight-chain alkyl group having 1 to 6 carbon atoms and a branched alkyl group having 1 to 6 carbon atoms, x and y are each a positive integer, and the sum of x and y is 1 to 16.

2. The toner according to claim 1, wherein when a carboxylic acid component containing a modified rosin is used in the carboxylic acid component for the polyester resin (A), the mass ratio [(B)/(A)] of the polyester resin (B) to the polyester resin (A) is 1/9 to 6/4.

3. The toner according to claim 1, wherein the modified rosin is at least one selected from a (meth)acrylic acid-modified rosin, a fumaric acid-modified rosin, and a maleic acid-modified rosin.

4. The toner according to claim 1, wherein the amount of the modified rosin contained in the carboxylic acid component for the polyester resin (A) is 5% by mass to 85% by mass.

5. The toner according to claim 1, wherein the purified rosin has a softening point of 50° C. to 100° C.

6. The toner according to claim 1, wherein the purified rosin is a purified tall rosin.

7. The toner according to claim 1, wherein the amount of the purified rosin contained in the carboxylic acid component for the polyester resin (A) is 2 mole % to 50 mole %.

8. The toner according to claim 1, wherein the alcohol component for the polyester resin (A) is an aliphatic polyhydric alcohol.

9. The toner according to claim 8, wherein the aliphatic polyhydric alcohol contains an aliphatic polyhydric alcohol having 2 to 6 carbon atoms.

10. The toner according to claim 1, wherein the polyester resin (A) contains at least one of a polyester resin containing a trivalent or higher polyhydric alcohol in the alcohol component for the polyester resin (A), and a polyester resin containing a trivalent or higher polyvalent carboxylic acid compound in the carboxylic acid component for the polyester resin (A).

11. The toner according to claim 1, wherein the polyester resin (A) contains a low-molecular-weight component having a molecular weight of 500 or less in an amount of 12% or less.

12. The toner according to claim 1, wherein the polyester resin (A) is obtained by polycondensation of the alcohol component with the carboxylic acid component in the presence of at least one of a titanium compound and a tin (II) compound having no Sn—C bond.

13. The toner according to claim 1, wherein the polyester resin (B) is obtained by polycondensation of the carboxylic acid component with an alcohol component which contains a divalent alcohol component containing the alkylene oxide adduct of bisphenol A represented by General Formula (1) in an amount of 80 mole % or more.

14. The toner according to claim 1, wherein the polyester resin (B) has a softening point Tm(B) of 80° C. to 160° C.

15. The toner according to claim 1, wherein the polyester resin (A) has an acid value of 25 mgKOH/g to 70 mgKOH/g, and the polyester resin (B) has an acid value of 1 mgKOH/g to 25 mgKOH/g.

16. A developer comprising:
a toner, and
a carrier,
wherein the toner comprises at least a binder resin, and a colorant,
wherein the binder resin comprises a polyester resin (A) which is obtained by polycondensation of an alcohol component with a carboxylic acid component containing one of a purified rosin and a modified rosin, and a polyester resin (B) which is obtained by polycondensation of a carboxylic acid with an alcohol component containing an alkylene oxide adduct of bisphenol A represented by General Formula (1) described below, and
wherein when the carboxylic acid component containing a purified rosin is used in the carboxylic acid component for the polyester resin (A), a mass ratio [(B)/(A)] of the polyester resin (B) to the polyester resin (A) is 2/8 to 6/4, 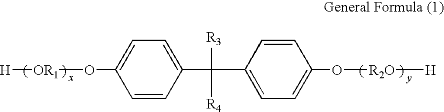
in General Formula (1), R₁ and R₂ are each an alkylene group having 2 to 4 carbon atoms, R₃ and R₄ are each any one of a hydrogen atom, a straight-chain alkyl group having 1 to 6 carbon atoms and a branched alkyl group having 1 to 6 carbon atoms, x and y are each a positive integer, and the sum of x and y is 1 to 16.
